(19) United States
(12) Patent Application Publication
(10) Pub. No.: US 2018/0128433 A1
(43) Pub. Date: May 10, 2018

(54) TANGLE-RESISTANT DECORATIVE LIGHTING ASSEMBLY

(71) Applicant: Willis Electric Co., Ltd., Taipei (TW)

(72) Inventor: Johnny CHEN, Taipei (TW)

(21) Appl. No.: 15/813,011

(22) Filed: Nov. 14, 2017

Related U.S. Application Data
(63) Continuation of application No. 15/335,197, filed on Oct. 26, 2016, now Pat. No. 9,845,925.
(60) Provisional application No. 62/246,423, filed on Oct. 26, 2015.

(51) Int. Cl. F21V 23/00; F21V 23/06; H01R 25/00; H01R 13/627; F21W 121/00

(52) U.S. Cl. CPC F21S 4/15; F21V 23/001; F21V 23/06; F21W 2121/00; H01R 13/627; F21S 4/10; F21W 2121/006; H01R 25/003

(57) ABSTRACT

A tangle-resistant decorative lighting assembly, comprising: a main portion including a plurality of wires and connectors, including first and second connectors and first and second lighted-extension portions extending transversely from the main portion. The first lighted extension portion including: a first connector configured to detachably connect to the first connector of the main portion, a first plurality of wires connected to the first connector, and a first plurality of lamp assemblies connected to the first plurality of wires. The second lighted-extension portion including: a second connector configured to detachably connect to the second connector of the main portion, a second plurality of wires connected to the second connector, and a second plurality of lamp assemblies connected to the second plurality of wires. The first connector of the main portion comprises a lock portion configured to engage with a lock portion of the first connector of the first lighted-extension portion.

### RELATED APPLICATIONS

The present application is a continuation of U.S. patent application Ser. No. 15/335,197, filed Oct. 26, 2016, entitled TANGLE-RESISTANT DECORATIVE LIGHTING ASSEMBLY, which claims the benefit of U.S. Provisional Application No. 62/246,423, filed Oct. 26, 2015, entitled TANGLE-RESISTANT DECORATIVE LIGHTING ASSEMBLY, which are incorporated herein by reference in their entireties.

### FIELD OF THE DISCLOSURE

The present invention is generally directed to decorative lighting. More specifically, the present invention is directed to decorative lighting assemblies, including net lights and icicle lights that are resistant to tangling and that provide consumer safety and convenience features.

### BACKGROUND OF THE INVENTION

Decorative lighting assemblies, and in particular net lights and “icicle” lights are traditionally assembled using elaborate patterns of interconnected wires and lights to form a particular desired shape or structure. Net lights, for example, often form rectangular or square outlines using zig-zag patterns of conductors powering incandescent or light-emitting diode (LED) lamps. Icicle lights, with their various draping lengths of series-connected lamps rely on lengths of twisted wires across a top section and for each “icicle” drop.

In both cases, the extensive lengths of wire conductors twisted together to form the desired shape or outline of such decorative assemblies results in a consumer product prone to tangling. Not only does such tangling of wires result in consumer frustration, but the untangling of the wires can result in wires being pulled from their connectors, resulting in potential safety hazards.

### SUMMARY OF THE INVENTION

Embodiments of the present disclosure provide decorative lighting assemblies, including net lights and icicle lights, that are less prone to tangling than traditional decorative lighting assemblies. As described below, the use of unique wire and lamp connectors, the layout of the wires, and in some cases, the reduction of wires between lamps, contributes to the tangle-resistant or tangle-reduced features of the embodiments.

In addition to the tangle-resistant features, an embodiment includes a decorative lighting assembly configured as an icicle light string that includes a main portion with detachably connected lighted-extension portions, or icicle drops. The connector system connecting the main portion and the lighted-extension portions includes features relating to safety and convenience, as described further below.

One embodiment includes a tangle-resistant decorative lighting assembly, comprising: a main portion including a plurality of wires and connectors, including first and second connectors and first and second lighted-extension portions extending transversely from the main portion. The first lighted extension portion including: a first connector configured to detachably connect to the first connector of the main portion, a first plurality of wires connected to the first connector, and a first plurality of lamp assemblies connected to the first plurality of wires. The second lighted-extension portion including: a second connector configured to detachably connect to the second connector of the main portion, a second plurality of wires connected to the second connector, and a second plurality of lamp assemblies connected to the second plurality of wires. The first connector of the main portion comprises a lock portion configured to engage with a lock portion of the first connector of the first lighted-extension portion.

Another embodiment includes decorative lighting connection system, comprising: a first connector for connection to a main portion of a decorative lighting assembly, the first connector including: a first body portion comprising a generally non-conductive portion and defining a first receiving channel; and a first lock portion; a second connector configured to connect to the first connector, the second connector including: a second body portion comprising a generally non-conductive portion and having a first portion configured to be inserted into the first channel of the first body portion of the first connector, the first portion of the second body defining a first channel; and a second lock portion configured to engage with the first lock portion; a first wire assembly including a first wire and a first electrically-conductive terminal connected to the first wire, the first electrically-conductive terminal and a portion of the first wire assembly located within the first receiving cavity; a second wire assembly including a second wire and a second electrically-conductive terminal connected to the second wire, the second electrically-conductive terminal and a portion of the second wire assembly located within the first receiving cavity; wherein the first connector is further configured such that insertion of the first portion of the first connector into the receiving cavity of the first connector causes the first electrically-conductive terminal to contact the second electrically-conductive terminal.

### BRIEF DESCRIPTION OF THE DRAWINGS

The invention can be understood in consideration of the following detailed description of various embodiments of the invention in connection with the accompanying drawings, in which:

FIG. 1 is a plan view showing an illustrative embodiment of a decorative lighting assembly;

FIG. 2 is a plan view showing an additional illustrative embodiment of the decorative lighting assembly shown in FIG. 1;

FIG. 3 is a plan view showing an additional illustrative embodiment of the decorative lighting assembly shown in FIG. 1;

FIG. 4 is a plan view showing an additional illustrative embodiment of the decorative lighting assembly shown in FIG. 1;

FIG. 5A is an exploded perspective view showing a power wire, an intermediate wire, and a bushing;

FIG. 5B is a perspective view showing the second power wire, the intermediate wire, and the bushing shown in of FIG. 5A;

FIG. 5C is a perspective view showing the second power wire, the intermediate wire, and the bushing shown in of FIG. 5A;

FIG. 6A is an exploded perspective view showing portions of a cord and a male portion of a fastener C;

FIG. 6B is an additional perspective view showing the cord and the male portion the fastener shown in FIG. 6A;

FIG. 6C is an exploded perspective view showing the male portion of the fastener and the female portion of the fastener shown in FIG. 6B;

FIG. 6D is an exploded perspective view showing the cord and first power wire of FIG. 6C coupled by the fastener;

FIG. 7A is a perspective view showing a connector;

FIG. 7B is a perspective view showing a connector;

FIG. 8A is a perspective view showing an alternate embodiment of the connector shown in FIG. 7A and FIG. 7B;

FIG. 8B is a plan view of the connector shown in FIG. 8A;

FIG. 9A is a perspective view showing an alternate embodiment of the connector shown in FIG. 7A and FIG. 7B;

FIG. 9B is a plan view of the connector shown in FIG. 9A;

FIG. 10A is an exploded perspective view showing a male portion of a connector and a female portion of the connector, a first portion of a power wire, a second portion of the power wire and an intermediate wire;

FIG. 10B is a partially assembled perspective view showing the male portion of the connector and the female portion of the connector shown in FIG. 10B;

FIG. 10C is an assembled perspective view showing the male portion of the connector and the female portion of the connector shown in FIG. 10B; and

FIG. 10D is a section view further illustrating the male portion of the connector and the female portion of the connector shown in FIG. 10B.

FIG. 11A is a prior art depiction of an icicle-light decorative lighting assembly;

FIG. 11B is another prior art depiction of an icicle-light decorative lighting assembly;

FIG. 12A is a perspective view of a decorative lighting assembly according to an embodiment of the present disclosure;

FIG. 12B is a partially exploded view of the decorative lighting assembly of FIG. 12A;

FIG. 13A is a perspective view of an embodiment of a female 2-wire connector and wires, according to an embodiment of the present disclosure;

FIG. 13B is a perspective view of the 2-wire connectors and wires of FIG. 13A assembled together;

FIG. 14A is a perspective view of an embodiment of a female 3-wire connector and wires, according to an embodiment of the present disclosure;

FIG. 14B is a perspective view of the 3-wire connector and wires of FIG. 13A assembled together;

FIG. 15A is a perspective view of a male 2-wire connector and wire assembly for connection to the female connector of FIGS. 13A and 13B;

FIG. 15B is a partially exploded view of view of 2-wire connector with wires of FIG. 15A;

FIG. 16 is a perspective view of the male and female connectors of FIGS. 13B and 15A coupled together;

FIG. 17 is a perspective view of the male and female connectors of FIGS. 14A and 15A coupled together;

FIG. 18A is a perspective view of a female 4-wire connector assembled with wires, according to an embodiment of the present disclosure;

FIG. 18B is a partially exploded view of the connector and wires of FIG. 18A;

FIG. 19 is a perspective view of the male and female connectors of FIGS. 18A and 15A coupled together;

FIG. 20 is a perspective view of another decorative lighting assembly according to an embodiment of the present disclosure;

FIG. 21 is a partially exploded view of the decorative lighting assembly of FIG. 12C;

FIG. 22A is a perspective view of an embodiment of a female 2-wire connector and wires, according to an embodiment of the present disclosure;

FIG. 22B is a perspective view of the 2-wire connectors and wires of FIG. 13A assembled together;

FIG. 23A is a perspective view of a 3-wire connector assembled to wires, according to an embodiment of the present disclosure;

FIG. 23B is a partially exploded view of the embodiment of the female 3-wire connector and wires of FIG. 23A;

FIG. 24A is a perspective view of a female 4-wire connector assembled with wires, according to an embodiment of the present disclosure;

FIG. 24B is a partially exploded view of the connector and wires of FIG. 24A;

FIG. 25A is a perspective view of a male 2-wire connector and wire assembly for connection to the female connector of FIGS. 22A and 22B;

FIG. 25B is a partially exploded view of view of the male 2-wire connector with wires of FIG. 15A;

FIG. 26 is a perspective view of the male and female connectors of FIGS. 22A and 25A coupled together;

FIG. 27 is a perspective view of the male and female connectors of FIGS. 23A and 25A coupled together;

FIG. 28 depicts the male and female connectors of FIGS. 24A and 25A coupled together;

FIG. 29A is a perspective view of an embodiment of a female 2-wire connector and wires, according to an embodiment of the present disclosure;

FIG. 29B is a perspective view of the 2-wire connectors and wires of FIG. 29A assembled together;

FIG. 29C is a cross-sectional view of the connector and wires of FIG. 29B;

FIG. 30A is a perspective view of a 3-wire connector assembled to wires, according to an embodiment of the present disclosure;

FIG. 30B is a partially exploded view of the embodiment of the female 3-wire connector and wires of FIG. 30A;

FIG. 31A is a perspective view of a female 4-wire connector assembled with wires, according to an embodiment of the present disclosure;

FIG. 31B is a partially exploded view of the connector and wires of FIG. 24A;

FIG. 32A is a perspective view of a male 2-wire connector and wire assembly for connection to the female connector of FIGS. 29A and 29B;

FIG. 32B is a partially exploded view of view of the male 2-wire connector with wires of FIG. 15A;

FIG. 32C is a sectional view of the male 2-wire connector of FIG. 32A with wires inserted;

FIG. 33A is a perspective view of the male and female connectors of FIGS. 29A and 32A coupled together;

FIG. 33B is a section view of the coupled connectors of FIG. 33A, with wires not depicted in sectional view;

FIG. 34 is a perspective view of the male and female connectors of FIGS. 31A and 32A coupled together; and

FIG. 35 is a perspective view of the male and female connectors of FIGS. 31A and 32A coupled together.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

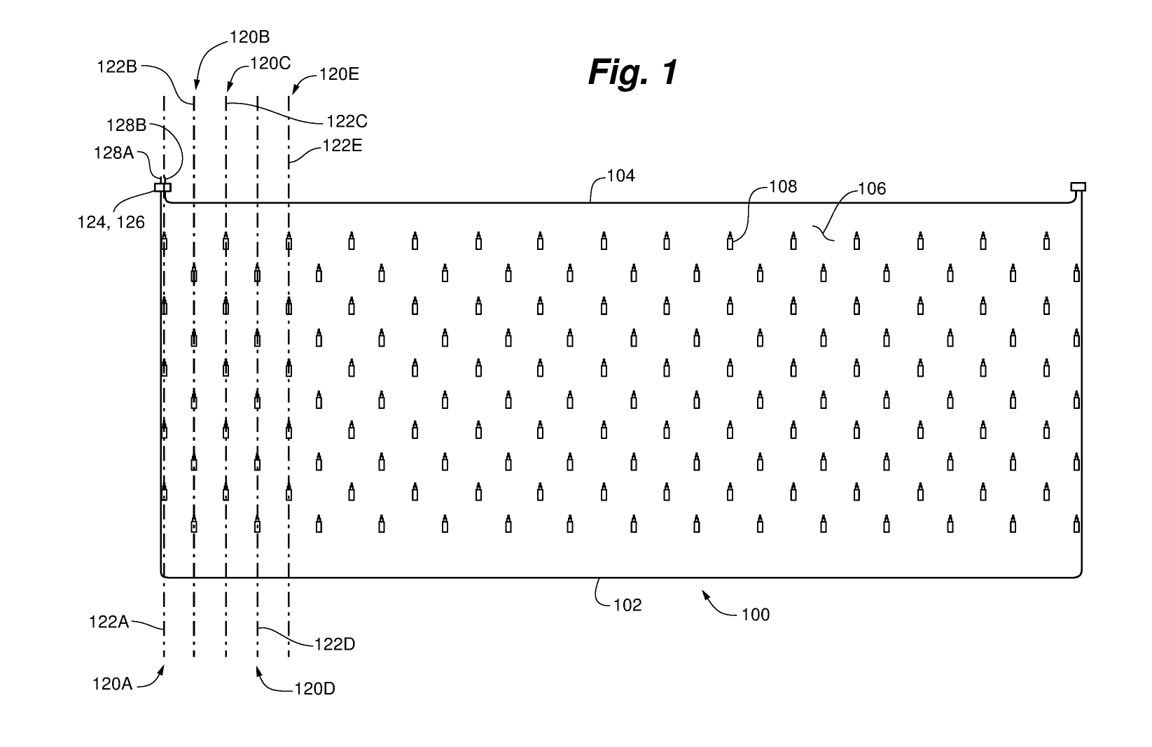

FIG. 1 is a plan view showing an illustrative embodiment of a decorative lighting assembly 100. Decorative lighting assembly 100 comprises a first power wire 102 and a second power wire 104. In FIG. 1, first power wire 102 and second power wire 104 are cooperating to surround a display area 106 of decorative lighting assembly 100. With reference to FIG. 1 it will be appreciated that decorative lighting assembly 100 includes a plurality of lamp assemblies 108 distributed across display area 106. The plurality of lamp assemblies 108 include a first column 120A of lamp assemblies 108 aligned along a first line 122A, a second column 120B of lamp assemblies 108 aligned along a second line 122B, and a third column 120C of lamp assemblies 108 aligned along a third line 122C.

A plurality of lamp assemblies 108 of decorative lighting assembly 100 may be inter-connected by wires to form one or more electrical circuits. A plurality of lamp assemblies 108 of decorative lighting assembly 100 may be mechanically coupled by cords which provide mechanical support. In some embodiments, the wires and the cords cooperate to form a net-like structure. In the embodiment of FIG. 1, the plurality of lamp assemblies 108 include a fourth column 120D of lamp assemblies 108 aligned along a first line 122D and a fifth column 120E of lamp assemblies aligned along a fifth line 122E.

Decorative lighting assembly 100 of FIG. 1 includes a power plug 124. Power plug 124 may comprise a traditional power plug comprising housing 126, first power terminal 128A and a second power terminal 128B for plugging into an outlet of an external power source, which may be an alternating-current (AC) power source. First power wire 102 is electrically connected to first power terminal 128A of power plug 124. Second power wire 104 is electrically connected to second power terminal 128B of power plug 124. In some embodiments, first power wire 102 and second power wire 104 may comprise a reinforced wire such as the reinforced wire described in published U.S. Patent Application US20150167944, filed Feb. 10, 2015, and entitled Decorative Lighting with Reinforced Wiring, which is herein incorporated by reference in its entirety.

With reference to FIG. 1, it will be appreciated that display area 106 of decorative lighting assembly 100 has a shape generally corresponding to a four-sided polygon. In the embodiment of FIG. 1, the shape of display area generally corresponds to a rectangle having a first long side, a second long side, a first short side, and a second short side. First power wire 102 defines the first short side, the first long side, and the second short side of a rectangle in the embodiment of FIG. 1. Second power wire 104 defines the second long side of a rectangle in the embodiment of FIG. 1.

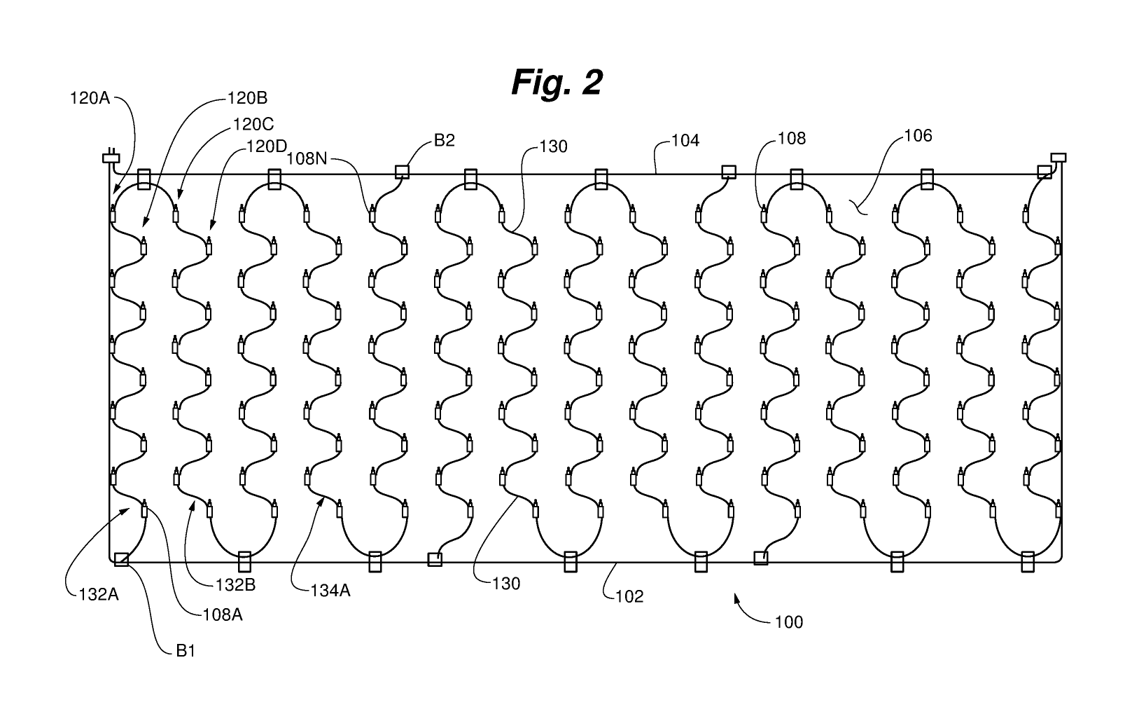

FIG. 2 is a plan view showing an additional illustrative embodiment of decorative lighting assembly 100 shown in the previous figure. Decorative lighting assembly 100 comprises a first power wire 102 and a second power wire 104. In FIG. 2, first power wire 102 and second power wire 104 are cooperating to surround a display area 106 of decorative lighting assembly 100. With reference to FIG. 2 it will be appreciated that decorative lighting assembly 100 includes a plurality of lamp assemblies 108 distributed across display area 106. The plurality of lamp assemblies 108 include a first column 120A of lamp assemblies 108, a second column 120B of lamp assemblies 108, a third column 120C of lamp assemblies 108, and a fourth column 120D of lamp assemblies 108.

In the embodiment of FIG. 2, a plurality of intermediate wires 130 are disposed along a first zig-zag path 132A connecting the lamp assemblies in first column 120A with the lamp assemblies in second column 120B. In some embodiments, decorative lighting assembly 100 may include a cord that is disposed along a second zig-zag path connecting the lamp assemblies in second column 120B with the lamp assemblies in third column 120C. In the embodiment of FIG. 2, decorative lighting assembly 100 includes a plurality of intermediate wires 130 that are disposed along a third zig-zag path 132C connecting the lamp assemblies in third column 120C with the lamp assemblies in fourth column 120D. In some embodiments, intermediate wires 130, first power wire 102 and second power wire 104 may comprise a reinforced wire such as the reinforced wire described in published U.S. Patent Application US20150167944, which is herein incorporated by reference in its entirety.

Decorative lighting assembly 100 of FIG. 2, includes a first series circuit 134A comprising a first lamp assembly 108A electrically connected to first power wire 102 at a connector B1 and an nth lamp assembly 108N electrically connected to second power wire 104 at a connector B2. In the embodiment of FIG. 2, a plurality of intermediate lamp assemblies 108 are electrically connected in series between first lamp assembly 108A and nth lamp assembly 108A.

With reference to FIG. 2, it will be appreciated that first series circuit 134 follows a winding path between connector B1 and connector B2 so that the lamp assemblies 108 are distributed across display area 106. In the embodiment of FIG. 2, the winding path of first series circuit 134 includes a plurality of intermediate wires 130 disposed along the first zig-zag path 132A connecting the lamp assemblies in first column 120A with the lamp assemblies 108 in second column 120B. First series circuit 134 also includes the plurality of intermediate wires 130 disposed along third zig-zag path 132C connecting the lamp assemblies 108 in third column 120C with the lamp assemblies 108 in fourth column 120D.

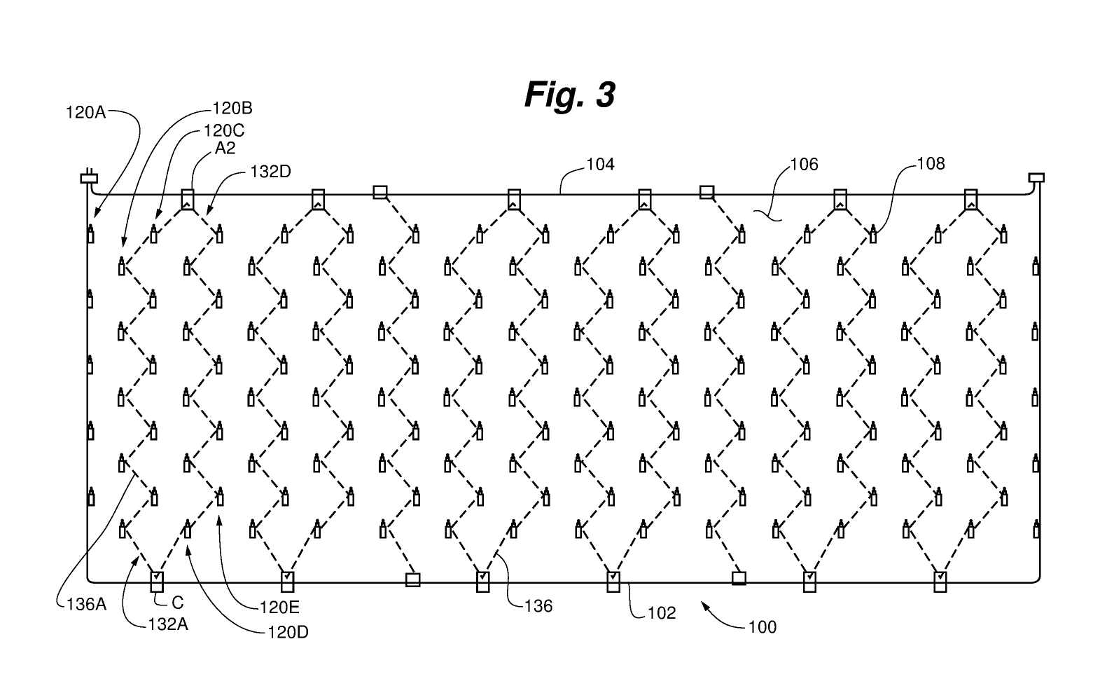

FIG. 3 is a plan view showing an additional illustrative embodiment of decorative lighting assembly 100 shown in the previous figure. Decorative lighting assembly 100 comprises a first power wire 102 and a second power wire 104. In FIG. 3, first power wire 102 and second power wire 104 are cooperating to surround a display area 106 of decorative lighting assembly 100. With reference to FIG. 3 it will be appreciated that decorative lighting assembly 100 includes a plurality of lamp assemblies 108 distributed across display area 106. The plurality of lamp assemblies 108 include a first column 120A of lamp assemblies 108, a second column 120B of lamp assemblies 108, a third column 120C of lamp assemblies 108, a fourth column 120 of lamp assemblies 108, and a fifth column 120E of lamp assemblies 108.

In the embodiment of FIG. 3, a plurality of lamp assemblies 108 of decorative lighting assembly 100 are mechanically coupled by cords 136 which provide mechanical support. In some embodiments, a plurality of lamp assemblies 108 of decorative lighting assembly 100 may be inter-connected by wires to form one or more electrical circuits. In some embodiments, the wires and the cords cooperate to form a net-like structure.

Decorative lighting assembly 100 of FIG. 1, includes a cord 136 that is disposed along a second zig-zag path 132A connecting the lamp assemblies in second column 120B with the lamp assemblies in third column 120C. In the embodiment of FIG. 3, cord 136 also extends along a fourth zig-zag path 132D connecting the lamp assemblies in fourth column 120D with the lamp assemblies in fifth column 120E. Cord 136 is illustrated using dashed lines in FIG. 3. In some embodiments, cord 136 may comprise a plurality of cord segments.

In the embodiment of FIG. 3, cord 136A comprises a single cord that extends through both second zig-zag path 132B and the fourth zig-zag path 132D. Decorative lighting assembly 100 of FIG. 3, includes a fastener C that mechanically couples a first end of cord 136A and a second end of cord 136A to first power wire 102. In the embodiment of FIG. 3, first power wire 102 extends through a passageway defined by fastener C.

Decorative lighting assembly 100 of FIG. 3 also includes a bushing A2 that mechanically couples an intermediate portion of cord 136A to second power wire 104. In the embodiment of FIG. 3, cord 136A and second power wire 104 extend through a passageway defined by bushing A2. Also in the embodiment of FIG. 3, cord 136A extends through a passageway defined by a clip of each lamp assembly 108 in second column 120A and each lamp assembly 108 in third column 120C.

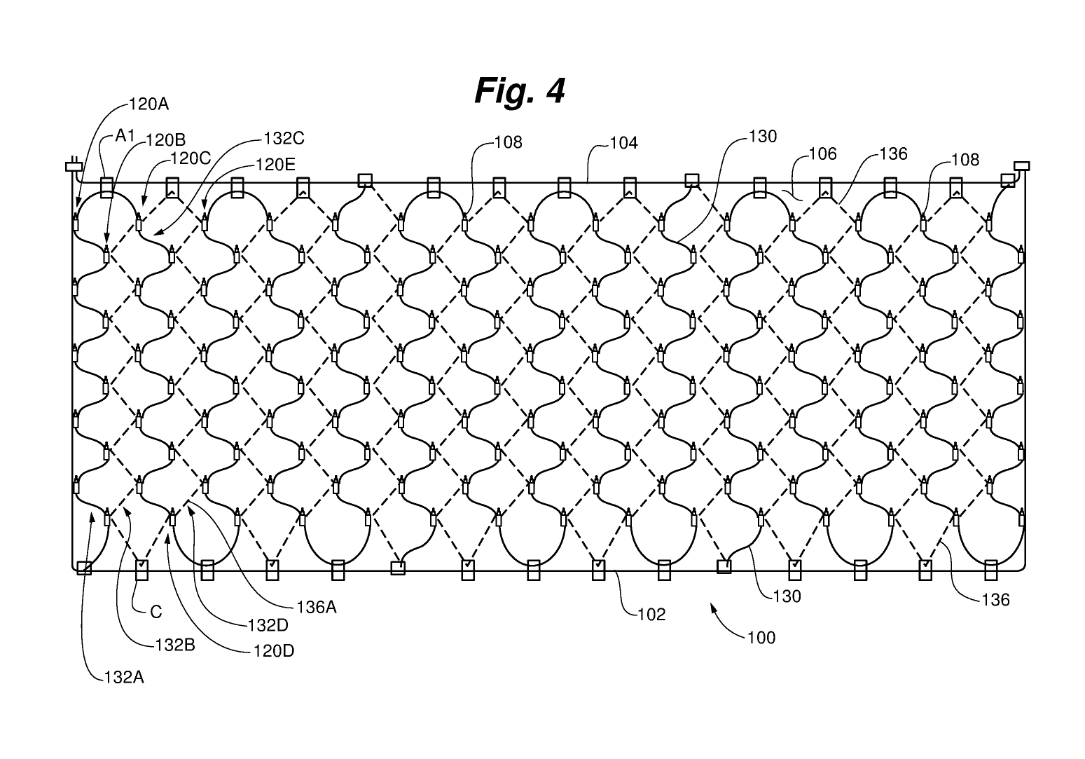

FIG. 4 is a plan view showing an additional illustrative embodiment of decorative lighting assembly 100 shown in the previous figure. Decorative lighting assembly 100 comprises a first power wire 102 and a second power wire 104. In FIG. 4, first power wire 102 and second power wire 104 are cooperating to surround a display area 106 of decorative lighting assembly 100. With reference to FIG. 4 it will be appreciated that decorative lighting assembly 100 includes a plurality of lamp assemblies 108 distributed across display area 106. The plurality of lamp assemblies 108 include a first column 120A of lamp assemblies 108, a second column 120B of lamp assemblies 108, a third column 120C of lamp assemblies 108, a fourth column 120 of lamp assemblies 108, and a fifth column 120E of lamp assemblies 108.

In the embodiment of FIG. 4, a plurality of lamp assemblies 108 of decorative lighting assembly 100 are inter-connected by intermediate wires 130 to form electrical circuits. Also in the embodiment of FIG. 4, a plurality of lamp assemblies 108 of decorative lighting assembly 100 are mechanically coupled by cords 136 which provide mechanical support. In the embodiment of FIG. 4, the wires and the cords cooperate to form a net-like structure. For purposes of illustration, the cords are illustrated using dashed lines and the wires are illustrated using solid lines in FIG. 4.

In the embodiment of FIG. 4, a plurality of intermediate wires 130 are disposed along a first zig-zag path 132A connecting the lamp assemblies in first column 120A with the lamp assemblies in second column 120B. Also in the embodiment of FIG. 4, decorative lighting assembly 100 includes a cord 136A that extends along a second zig-zag path 132B connecting the lamp assemblies in second column 120B with the lamp assemblies in third column 120C. A plurality of intermediate wires 130 are disposed along a third zig-zag path 132C connecting the lamp assemblies in third column 120C with the lamp assemblies in fourth column 120D. In the embodiment of FIG. 4, cord 136A extends along a fourth zig-zag path 132D connecting the lamp assemblies in fourth column 120D with the lamp assemblies in fifth column 120E. Cord 136A is illustrated using dashed lines in FIG. 4. In some embodiments, cord 136A may comprise a plurality of cord segments.

In the embodiment of FIG. 4, cord 136A comprises a single cord that extends through both second zig-zag path 132B and the fourth zig-zag path 132D. Decorative lighting assembly 100 of FIG. 4, includes a fastener C that mechanically couples a first end of cord 136A and a second end of cord 136A to first power wire 102. In the embodiment of FIG. 4, first power wire 102 extends through a passageway defined by fastener C.

With reference to FIG. 4, it will be appreciated that a top-most intermediate wire extends between a top-most lamp assembly in first column 120A and a top-most lamp assembly in third column 120C. In the embodiment of FIG. 4, a bushing A1 mechanically couples an intermediate portion of the first top-most intermediate wire to second power wire 104. In the embodiment of FIG. 4, the second power wire 104 and the top-most intermediate wire extend through a passageway defined by bushing A1.

In some embodiments of decorative lighting assembly 100, the intermediate wires 130 have a first outer diameter, the cords 136 have a second outer diameter, and the second outer diameter is substantially equal to the first outer diameter so that decorative lighting assembly 100 has a uniform appearance.

In some embodiments of decorative lighting assembly 100, the intermediate wires 130 comprise a plurality of conductor strands and an outer insulating layer adjacent to, and covering, one or more of the conductor strands. The cords 136 may comprise a solid strand. In some embodiments of decorative lighting assembly 100, the insulating layer of the intermediate wires 130 and the solid strand of the cords 136 comprise the same material so that the decorative lighting assembly has a uniform appearance. In some embodiments of decorative lighting assembly 100, the insulating layer of the intermediate wires 130 and the solid strand of the cords 136 are substantially the same color so that the decorative lighting assembly has a uniform appearance.

In some embodiments of decorative lighting assembly 100, the first power wire comprises 18 AWG wire, the second power wire comprises 18 AWG wire, and the intermediate wires comprise 22 AWG wire.

In some embodiments of decorative lighting assembly 100, the first power wire comprises 18 AWG wire, the second power wire comprises 18 AWG wire, and the intermediate wires comprise 22 AWG reinforced wire.

In some embodiments of decorative lighting assembly 100, the first power wire comprises 18 AWG wire, the second power wire comprises 18 AWG wire, and the intermediate wires comprise 25 AWG reinforced wire.

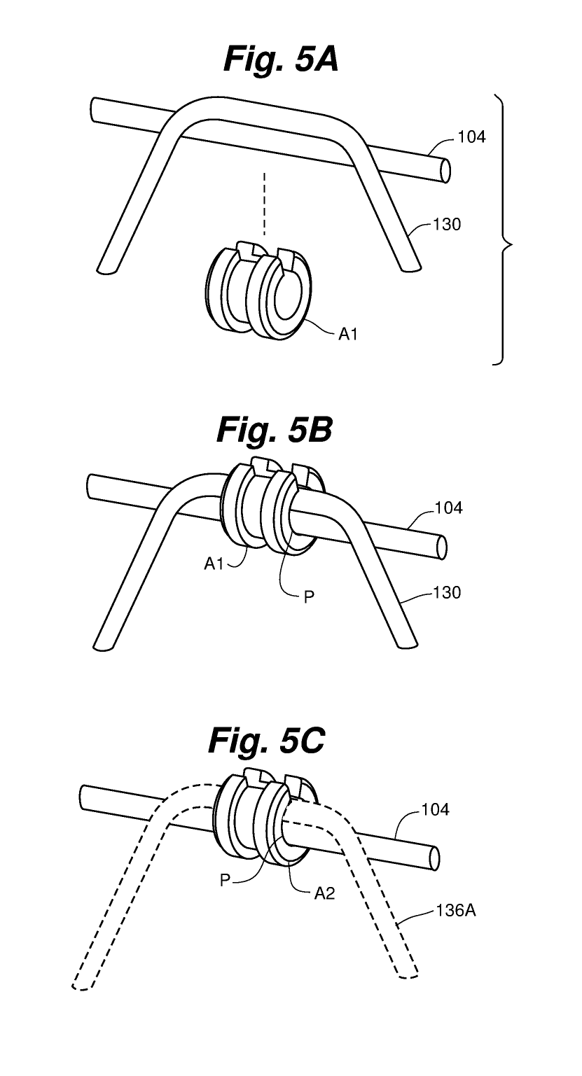

FIG. 5A is an exploded perspective view showing a second power wire 104, an intermediate wire 130, and a bushing A1. FIG. 5B is a perspective view showing second power wire 104, intermediate wire 130, and bushing A1 of FIG. 5A in an assembled state. In FIG. 5B, intermediate wire 130 and second power wire 104 can be see extending through a passageway P defined by bushing A1.

FIG. 5C is a perspective view showing a second power wire 104, a cord 136, and a bushing A2. In the embodiment of FIG. 5C, cord 136A and second power wire 104 extend through a passageway P defined by bushing A2.

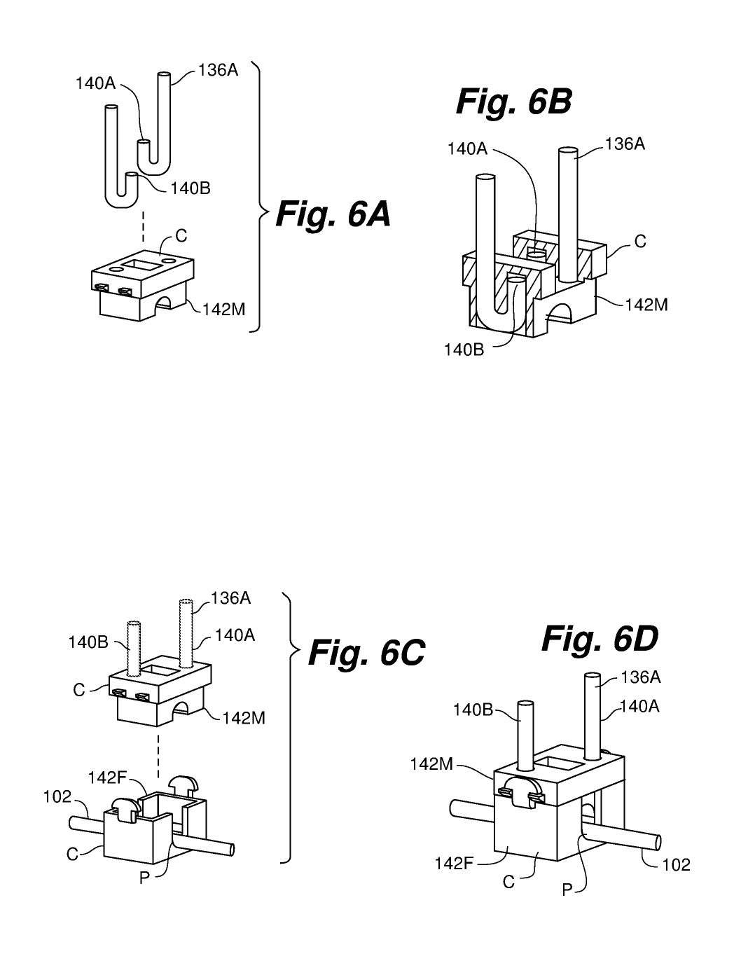

FIG. 6A is an exploded perspective view showing portions of a cord 136A and a male portion 142M of fastener C. A first end 140A and a second end 140B of cord 136A are visible in FIG. 6A.

FIG. 6B is an additional perspective view showing portions of cord 136A and male portion 142M of fastener C. In the embodiment of FIG. 6B, first end 140A and second end 140B of cord 136A are fixed to male portion 142M of fastener C.

FIG. 6C is an exploded perspective view showing a male portion 142M of fastener C and a female portion 142F of fastener C. In the embodiment of FIG. 6C, first end 140A and second end 140B of cord 136A are fixed to male portion 142M of fastener C. In FIG. 6C, a first power wire 102 can be seen extending through a passageway P defined by female portion 142F of fastener C.

FIG. 6D is an exploded perspective view showing cord 136 coupled to first power wire 102A by fastener C. In the embodiment of FIG. 6D, first end 140A and second end 140B of cord 136A are fixed to male portion 142M of fastener C. In FIG. 6D, first power wire 102 can be seen extending through a passageway P defined by fastener C.

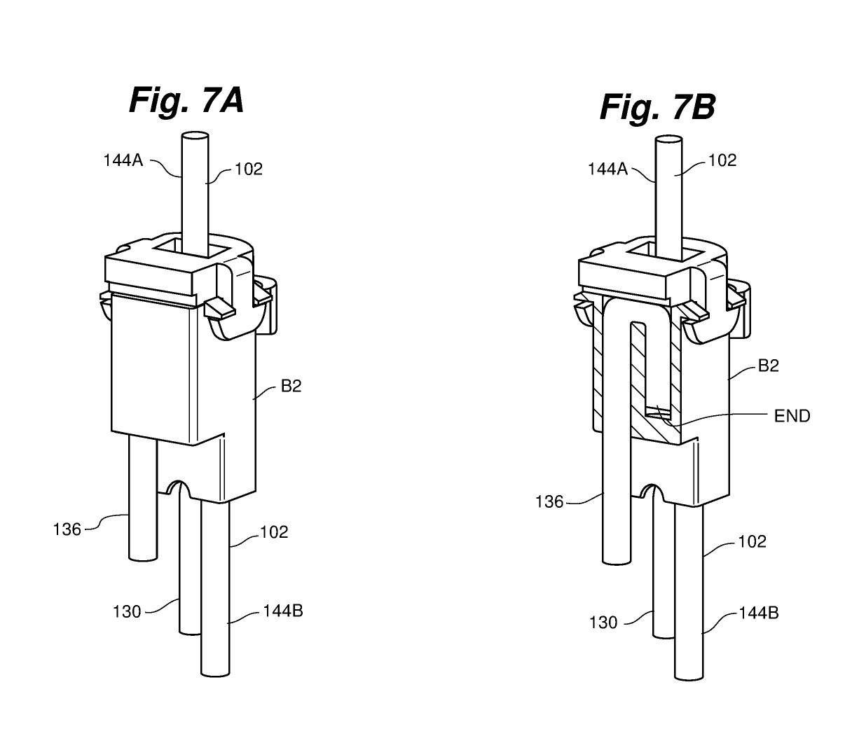

FIG. 7A is a perspective view showing a connector B2. In the embodiment of FIG. 7A, a first portion 144A of a power wire 102, a second portion 144B of power wire 102 and an intermediate wire 130 are electrically connected to each other by connector B2. The embodiment of FIG. 7A also includes a cord 136. In the embodiment of FIG. 7A, cord 136, first portion 144A of power wire 102, second portion 144B of power wire 102, and intermediate wire 130 are all mechanically coupled to each other by connector B2.

FIG. 7B is a perspective view showing a connector B2. In the embodiment of FIG. 7B, connector B2 is sectioned so that one end of cord 136 can be seen captured inside connector B2. In the embodiment of FIG. 7B, cord 136, first portion 144A of power wire 102, second portion 144B of power wire 102, and intermediate wire 130 are all mechanically coupled to each other by connector B2. First portion 144A of a power wire 102, a second portion 144B of power wire 102 and an intermediate wire 130 are electrically connected to each other by connector B2 in the embodiment of FIG. 7B.

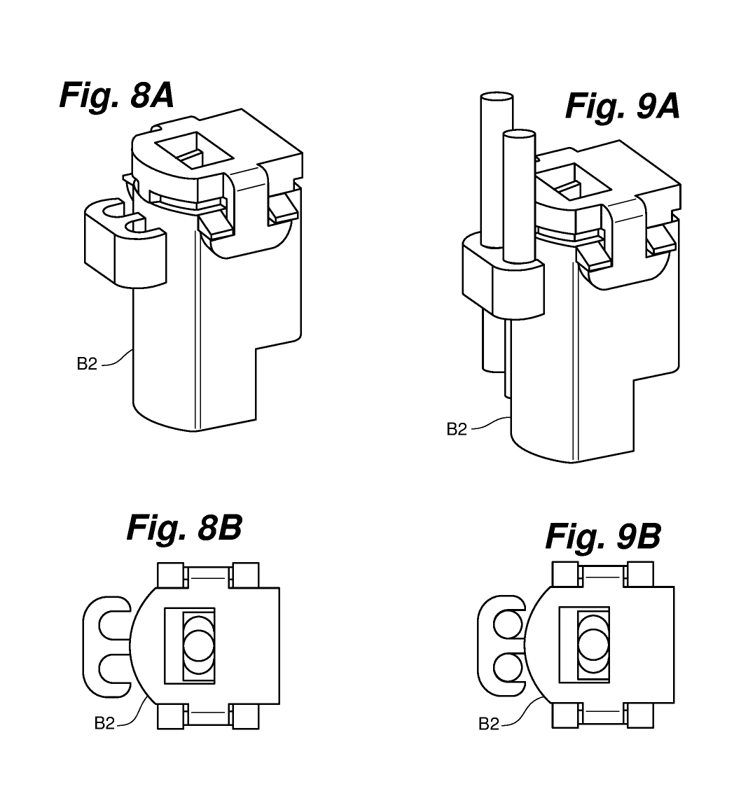

FIG. 8A is a perspective view showing an alternate embodiment of connector B2 shown in FIG. 7A and FIG. 7B.

FIG. 8B is a plan view showing the connector B2 shown in FIG. 8A.

FIG. 9A is a perspective view showing an alternate embodiment of connector B2 shown in FIG. 7A and FIG. 7B.

FIG. 9B is a plan view showing the connector B2 shown in FIG. 9A.

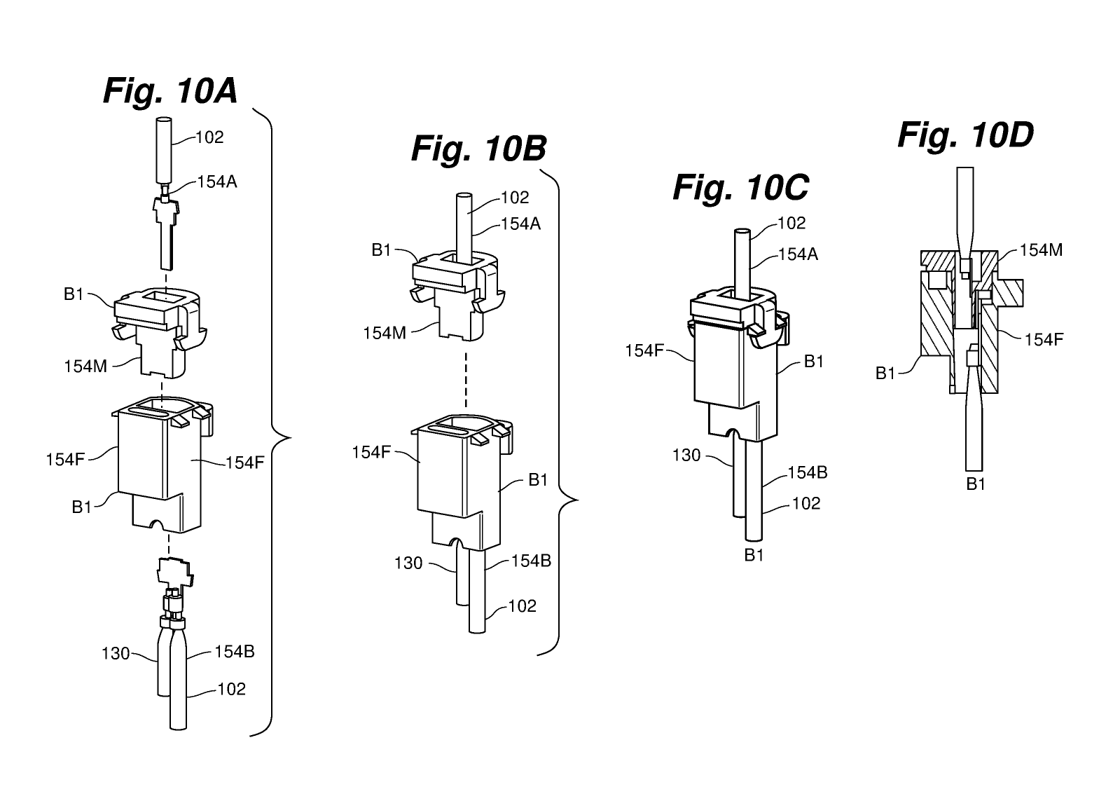

FIG. 10A is an exploded perspective view showing a male portion 154M of connector B1 and a female portion 152F of connector B1. A first portion 154A of a power wire 102, a second portion 154B of power wire 102 and an intermediate wire 130 are all illustrated in the exploded view of FIG. 10A.

FIG. 10B is a partially assembled perspective view showing male portion 154M of connector B1 and female portion 152F of connector B1. In the embodiment of FIG. 10B, first portion 154A of power wire 102 has been inserted into male portion 154M of connector B1. Also in the embodiment of FIG. 10B, a second portion 154B of power wire 102 and an intermediate wire 130 have been inserted into female portion 154F of connector B1.

FIG. 10C is an assembled perspective view showing a male portion 154M of connector B1 and a female portion 152F of connector B1. In the embodiment of FIG. 10C, male portion 154M of connector B1 has been inserted into female portion 152F of connector B1. First portion 154A of power wire 102, second portion 154B of power wire 102 and intermediate wire 130 all are electrically connected to each other by connector B2 in the embodiment of FIG. 10C. First portion 154A of power wire 102, second portion 154B of power wire 102, and intermediate wire 130 are also mechanically coupled to each other by connector B2 in the embodiment of FIG. 10C.

FIG. 10D is a section view further illustrating male portion 154M of connector B1 and female portion 152F of connector B1.

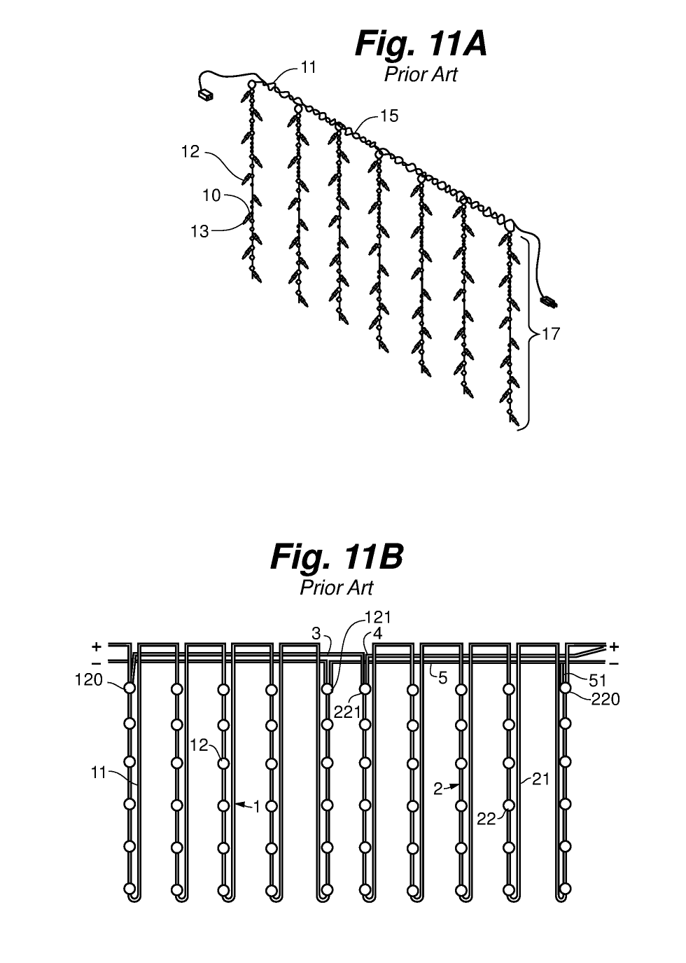

Referring first to FIGS. 11A and 11B, prior-art icicle light assemblies depicted. Referring to FIG. 11A, in this traditional decorative lighting assembly, segments of wires, i.e., insulated electrical conductors, interconnect multiple lamp holders 10 with lamps 13. The structure includes a top, horizontally extending portion 15 comprising twisted portions of wires, as well as multiple vertically extending portions of “icicle” drops 17 with lamps wired, typically, in an electrical series connection.

Referring also to FIG. 11B, a schematic of a typical prior-art icicle light assembly before twisting is depicted. As depicted, long strands of wires interconnect lamps 12 and 22.

Typically, such known decorative lighting structures form one integral, contiguous lighting assembly not intended to be separated, save for lamps.

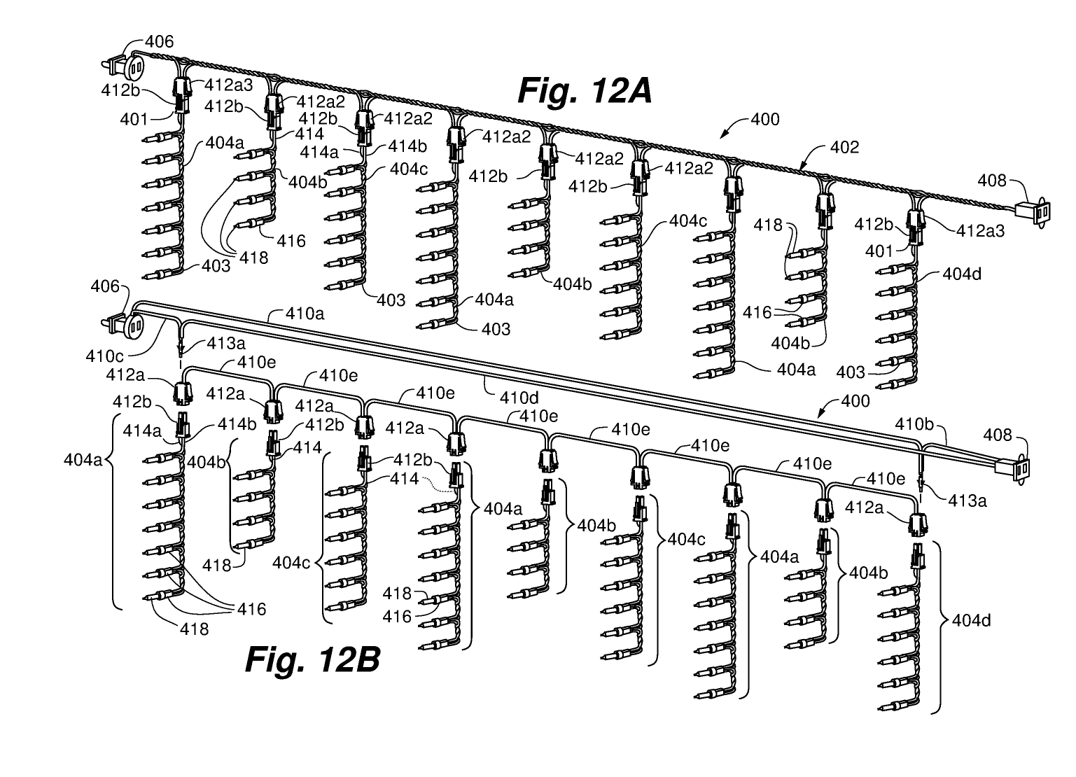

Referring to FIGS. 12A-35, embodiments of tangle-resistant decorative lighting assemblies and connectors for “icicle” lights of the disclosure are depicted.

As described further below, embodiments of the present disclosure may employ some traditional wire-twisting features found in the prior art, but are distinguished in part by the wiring and connection structures that allow individual icicle drops to be connected and disconnected from the main horizontal wiring. As will also be described further below, the connectors and wiring structures not only provide features convenient to consumers using the lighting assemblies, but also provide benefits relating to ease of manufacturing.

Referring to FIGS. 12A and 12B, an embodiment of decorative lighting assembly 400 in the form of an icicle light assembly is depicted. FIG. 12A depicts a fully-assembled version of decorative lighting assembly 400, while in FIG. 12B, a partially-disassembled version of decorative lighting assembly 400 is depicted.

In an embodiment, and as depicted, decorative lighting assembly 400 includes main portion 402 and a plurality of lighted extension portions 404, including lighted-extension portions 404a, 404b, 404c and 404d. In an embodiment, main portion 402 extends horizontally, or latitudinally, while lighted-extension portions 404 extend vertically or longitudinally from main portion 402. In an embodiment, lighted-extension portions 404 extend perpendicularly or transversely to main portion 502, when assembled and in a display position. In an embodiment, and as depicted, lighted-extension portions 402 are not coupled to one another.

Because lighted-extension portions 404 are detachably coupled to main portion 402, they may be detached and replaced in the event of a failure of lamp assemblies, connectors, and so on. Further, the detachable nature of lighted-extension portions 404 allows different configurations of lighted-extension portions to be exchanged. As depicted in the figures, each portion 404 is intended to be an “icicle strand” or “icicle drop”, giving the appearance of winter icicles, perhaps displayed at a rooftop edge. In other embodiments, the icicle-drop style portion 404 may be replaced with another electrically-compatible portion 404, such as lighted ornament (typically some sort of housing with a plurality of lamp assemblies). In another embodiment, portions 404 having lamps of a particular color may be exchanged for lamps of another color, allowing for mixing and matching by a user to create a desired color scheme.

Consequently, in an embodiment, decorative lighting assembly 400 may comprise a set comprising main portion 402 and lighted-extension portions 404, wherein more extension portions 404 than can be accommodated by main portion 402, e.g., main portion 402 has connectors for 8 lighted-extension portions 404, but 16 are provided. The extra portions 404 may be interchangeable, and comprise different colors, comprise ornaments, or comprise other lighting and decorative features.

In an embodiment, main portion 402 includes power plug 406, optional end-power connector 408, main wiring 410, and a plurality of connectors 412a.

In an embodiment, power plug 406 is configured to be inserted into an external supply of power, such as a wall socket. In other embodiments, power plug 406 may be configured to connect to alternative source of power or control device.

Optional end-power connector 408, in an embodiment, is configured to provide power to another decorative light assembly, such as another decorative light assembly 400.

Main wiring 410, in an embodiment, comprises a plurality of wires or wire segments. In an embodiment, and as depicted, main wiring 410 includes wires 410a, 410b, 410c, 410d and a plurality of wires 410e. In this embodiment, wires 410a and 410b are mechanically and electrically connected, while wires 410c and 410d are electrically connected. As also depicted, an end of wire 410 is mechanically and electrically connected to a first electrical terminal of power plug 406, and end of wire 410b is connected to a first electrical terminal of optional end-power connector 408.

Wires 410c and 410d are mechanically and electrically connected to one another, with an end of wire 410c connected to a second terminal of power plug 406, while an end of wire 410d is connected to a second terminal of end-power connector 408.

Wires 410e electrically connect connectors 412a. In an embodiment, wires 410e connect to connectors 412a such that connectors 412a (and 412b) and lamp assemblies of lighting-extension portions 404 are electrically connected in series.

In an embodiment, connectors 412a may be configured to receive two or more wires. In an embodiment, connectors 412a may be configured to receive two, three or four wires. More specifically, connectors 412a3 are configured to receive three wires, such as 410c, 410d and 410e. Connectors 412a2 are configured to receive two wires, such as a pair of wires 410e. Embodiments of connectors 412, including connectors 412a2 and 412a3 are described further below.

In some embodiments, some or all of wires 410 may comprise a reinforced wire such as the reinforced wire described in published U.S. Patent Application US20150167944, filed Feb. 10, 2015, and entitled Decorative Lighting with Reinforced Wiring, which is herein incorporated by reference in its entirety.

In this electrical configuration, when power is applied to power plug 406, power is also available at end-power connector 408. Wires 410a and 410b may be considered first polarity wires, such as positive, live or hot, and wires 410c and 410d may be considered second polarity wires, such as negative, or neutral.

As will be described further below, ends of wires may be joined together with electrically-conductive terminals 413. In an embodiment, terminals 413 not only couple wires together, but also serve to connect wires to connectors 412a and connectors 412b of lighting extension portions 410, as also described further below.

In an embodiment, each lighted-extension portion 404, including lighted-extension portions 404a, 404b, 404c and 404d, includes connector 412b, a plurality of multiple lamp wires 414, lamp holders 416 and lamp assemblies 418. Each lighted-extension 404 defines a connector end 401 and a free end 403. In an embodiment, connector end 401 is connected to main portion 402, while free end 403 is not connected to main portion 402 or other lighted-extension portions 404. In one such embodiment, except for the connection of end 401 to main portion 402, lighted-extension portions 404 do not connect to any other adjacent structures. In an embodiment, connector pair 412a/412b is not the same as lamp holder 416. In an embodiment, connectors 412a and 412b form a decorative lighting connector system, and more specifically, a decorative lighting lighted-extension connection system.

As described further below, each connector 412b of lighting-extension portion is configured to mechanically and electrically connect to a connector 412a of main portion 402. In some embodiments, and as depicted, connector pairs 412a and 412b are intended to be detachably coupled. In other embodiments, connector pairs 412a and 412b are not detachably coupled, and are not intended to be easily detached from one another by a consumer after manufacturing assembly.

Lamp wires 414 electrically connect connector 412b to lamps 418, and connect lamps 418 to other lamps 418, in each lighting-extension portion 404. In an embodiment, lamp wires 414 may be twisted about one another as depicted.

In an embodiment, a wire 414, such as 414a is connected to a first terminal of a connector 412b, while another wire 414, such as 414b, is connected to a second terminal of the connector 412b. In a series connected lighting assembly, such as is depicted, wire 414a is electrically connected to a first lamp 418 (nearest the connector 412b) in the lighting-extension portion 404, while wire 414b is electrically connected to a last lamp 418 in the lighting-extension portion 404.

In the depicted embodiment, lighted-extension portion 404a includes seven lamp assemblies 418, lighted-extension portion 404b includes four lamp assemblies 418, lighted-extension portion 404c includes six lamp assemblies 418, and lighted-extension portion 404d includes five lamp assemblies 418. The number of lamp assemblies per lighted-extension portion 404 may vary depending on the light pattern desired, and be different from that depicted.

In the embodiment depicted, decorative lighting assembly 400 includes 50 lamp assemblies 418 in total, with each lamp assembly wired to the other in electrical series. In one such embodiment, each lamp assembly is rated for approximately 2.5 volts, with an expectation that decorative lighting assembly 400 will be powered by an external alternating current (AC) power source providing approximately 125 VAC.

In other embodiments, lamp assemblies 418 may be wired in parallel, as described below, or may be wired in parallel series.

Lamp assemblies 418 may comprise incandescent lamps or LEDs, configured to operate on AC or DC power, and having various voltage ratings, as will be understood by those of ordinary skill.

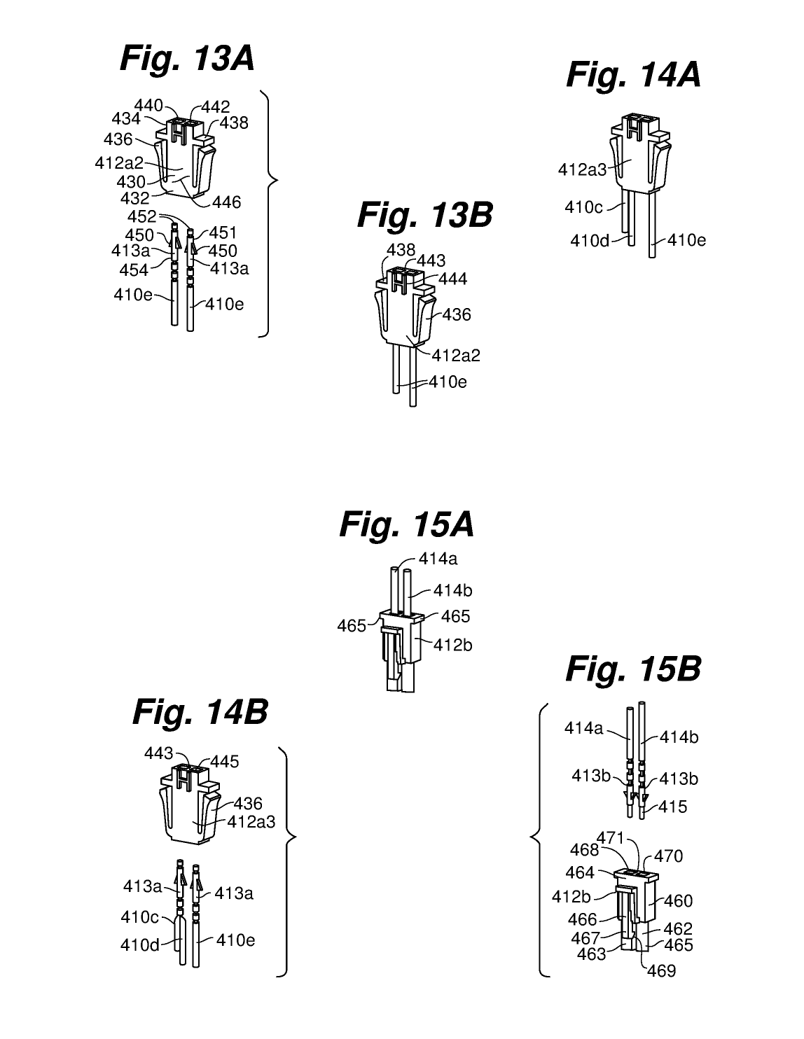

Referring to FIGS. 13A to 16B, embodiments of connectors 412a and 412b are depicted.

Referring specifically to FIGS. 13A and 13B, connector 412a2 is depicted. In the embodiment depicted, connector 412a2 includes generally non-conductive body portion 430, first end 432, and second end 434. In an embodiment, body portion 430 includes a pair of user-gripping portions 436 and a pair of tabs 438. User-gripping portions 436, in an embodiment, are configured to be gripped or grasped by a user to assist in separating connector 412a and connector 412b, and may comprise a pair of projections joined to body portion 430 at first end 432. User-gripping portions 436 may be configured to bend or pivot at their respective connection points to end 432. Optional tabs 438, when present may prevent a user's hand from slipping off of connector 412a, when gripping portions 436 and pulling.

First end 432 of connector 412a (412a2 in this embodiment), defines one or more openings or channels configured to receive terminals 413, including terminals 413a, and wires, such as 410e.

Second end 434 of connector 412a defines a first receiving channel 440 and a second receiving channel 442. Channels 440 and 442 may extend through body portion 430 to form the channels in first end 432. In an embodiment, channels 440 and 442 are two separate and distinct channels separated by an inner structure, such as a wall 443. In another embodiment, not depicted, channels 440 and 442 combine to form a single channel to receive end 462 of connector 412b, as described further below.

In an embodiment, channels 440 and 442 define dissimilar shapes such that connector 412b may only be coupled to connector 412a in a single orientation. In an embodiment, and as depicted, channel 440 defines a circular opening and a cylindrical channel, while channel 442 defines a square opening. In an embodiment, channels 440 and 442 extend the entire length of body portion 430.

As described further below, channels 440 and 442 are each configured to receive a portion of connector 412b.

In an embodiment, body portion 430 includes lock portion 444 on surface 446. Lock portion 444 is configured to detachably receive a lock portion of connector 412b, as will be described further below. In the embodiment depicted and described, the lock portion of the connectors may be locked and unlocked by a user without the necessity of tools, i.e., can be locked and unlocked by hand. This contrasts with a locking feature described further below in an alternate embodiment where locking and unlocking requires that an end user utilize a tool.

Still referring to FIGS. 13A and 13B, a pair of terminals 413a are attached to a pair of wires 410e, respectively.

In an embodiment, each terminal 413a includes a pair of barbs or projections 450 attached at one end to a body portion 451 and configured to pivot about at the attached end. Projections 450 may take other shapes as needed to cooperate with connector 412 for attachment.

Body portion 451, in an embodiment, defines an opening or channel 452 configured to receive an end, or male portion, 415 of terminal 413b of connector 412b. Body portion 451, in an embodiment, defines a lengthwise slot 454, such that terminal 413a comprises a spring, and is able to be radially expanded or contracted when terminal 413b is inserted, or removed from, terminal 413a.

Each terminal 413a is configured to be crimped onto, or otherwise connected to, a conductive portion of a wire, such as a wire 410e, such that terminal 413a is in mechanical and electrical connection with the wire 410.

As depicted, terminal 413a, and a portion of wire 410e is inserted into connector body 430 at end 432, and into channels 440 and 442. In an embodiment, when inserted into connector 412a, projections, or barbs, 450, engage an inside surface or structure of connector 412a, preventing terminal 413a from easily being pulled back out of connector 412a after initial insertion.

Referring to FIGS. 15A and 15B, an embodiment of connector 412b is depicted. In an embodiment, connector 412b is a male connector configured to couple with a female connector, such as connector 412a, including connector 412a2, and in some embodiments with any of connectors 412a2 (2-wire), 412a3 (3-wire), or 412a4 (4-wire). In an embodiment, connector 412b is simply a 2-wire connector, though in other embodiments not depicted, connector 412b is configured to receive 3-6 wires, including 3 wires or 4 wires. Although connector 412a is described as being a “female” connector, and connector 412b is described as being a “male” connector, it will be understood that in other embodiments, connector structure may be exchanged between connectors or connector portions such that connector 412a may comprise a male connector and connector 412b may comprise a female connector.

In an embodiment, connector 412b includes body portion 460, first end 462, which is an insertion end, and second end 464 which is a wire-receiving end. Second end 464 may also include one or more tabs 465, which may be contacted by a user to assist with pushing or pulling connector 412b. Connector 412b also includes lock portion 466, and defines channels 468 and 470, divided by wall 471. In an embodiment, channels 468 and 470 extend the entire length of body portion 460.

First end 462, in an embodiment, is configured to be inserted into connector 412a. In an embodiment, first end 462 includes structure defining a shape complementary to the shapes defined by channels 440 and 442, and thereby first end 462 is insertable into end 434 of connector 412a. As depicted, a portion of end 462 defines a complementary circular, cylindrical shape and another portion defines a square shape, to fit into channels 440 and 442, respectively. In an embodiment, first end 462 comprises first side or portion 463 corresponding to the circular, cylindrical shape and configured to fit into channel 440, and second side or portion 465 corresponding to the square-ended shape and configured to fit into channel 442. In one such embodiment, portions 463 and 465 are separated by a space intended to receive wall 443 so as to enable end 462 to fit into end 434.

When connector 412b is inserted into connector 412a, in an embodiment, channel 468 aligns with channel 440 to form a first continuous channel in the coupled pair of connectors, and channel 470 aligns with channel 442 to form a second continuous channel in the coupled pair of connectors 412a and 412b. In an embodiment, “continuous” means that portions of channel 468 and channel 440, or portions of 470 and 441, overlap, or share a common space.

Lock portion 466, in an embodiment, comprises a projection or arm having an end that is connected proximal end 464 of clip 412b, and having a free end 467 proximal end 462, such that the free end may be moved away from body portion 460. Free end 467 may define an angled surface 469 for contacting, and sliding over lock portion 444 of clip 412a.

Also depicted in FIG. 15B is an embodiment of terminal 413b connected to a wire 414. In an embodiment, terminal 413b is substantially similar to terminal 413a, except that terminal 413b includes end 415 that may form a pin insertable into channel 452 of terminal 413a. In an embodiment, end 415 may include a recess or a slot, such that the end may be expanded or contracted.

As depicted in FIG. 15A, wires 414, including wire 414a and 414b are connected to terminals 413b and inserted into channels 468 and 470.

Referring to FIG. 16, connector 412a, specifically a 2-wire connector 412a2, is detachably coupled to connector 412b by inserting end 462 of connector 412b into channels 440 and 442 of end 434 of connector 412a. As depicted, lock portion 466 engages 444, thereby detachably coupling connector 412a2 to connector 412b. A user may disconnect connector 412a2 from connector 412b by lifting free end 467 away from the connectors, grasping user-grip portions 436, and pulling the connectors apart.

When coupled, each terminal 413a makes contact or electrical connection with a corresponding terminal 413b. In an embodiment, end 415 of terminal 413b is received by recess 452, thereby connecting a terminal 413a with a terminal 413b. It will be understood that other structures of terminals 413a and 413b may be used to electrically connect connectors 412a and 412b and their respective wires. For example, terminals 413a and 413b may comprise male and female blade terminals, or other times of electrical connectors and terminals, including push-on connectors, electrical quick-disconnect connectors, and so on.

Connection of terminals 413a and 413b may occur in channels 468, 470, 440, 442, or a combination thereof.

The securement and alignment of wires 414 into connector 412b as well as the securement and alignment of wires 410 into connector 412a, avoids or reduces torsional forces imparted by twisting of wires 414 or 410 to be transferred from main portion 502 to any of the lighting-extension portions 404, helping keep the structural shape of the decorative lighting, and helping to keep it tangle free.

Consumers also benefit from the detachable feature of connector pair 412a/412b. Whole lighting-extension portions 404 may be replaced as an assembly by the consumer as needed by uncoupling and coupling simple connectors, rather than replacing individual lamp assemblies, or other wiring.

Further, from a manufacturing point of view, decorative lighting assembly 400 provides significant savings by keeping construction and assembly of main portion 402 separate and distinct from lighting-extension portion 404 (icicle drop portion). In this manner, a generic main portion 402 can be assembled, while different lighting-extension portions 404 may be separately manufactured, and added as needed to main portion 402.

Referring to FIGS. 14A and 14B, an embodiment of connector 412a3 is depicted. In an embodiment, connector 412a3 is substantially the same as connector 412a2, except for channels 443 and 445. In an embodiment, channels 443 and 445 are substantially the same as channels 440 and 442 of connector 412a2, except that channels 443 and 445 may be slightly larger or otherwise configured, to each accommodate two wires rather than three wires.

In another embodiment, connectors 412a2 and 412a3 are identical. In such an embodiment, channels, such as 440 and 443 are large enough to receive two wires, rather than one.

In an embodiment, terminals 413, may have slightly larger ends configured to crimp to wires, such as wires 410e, such that one terminal 413 may crimp and connect to two wires 410e.

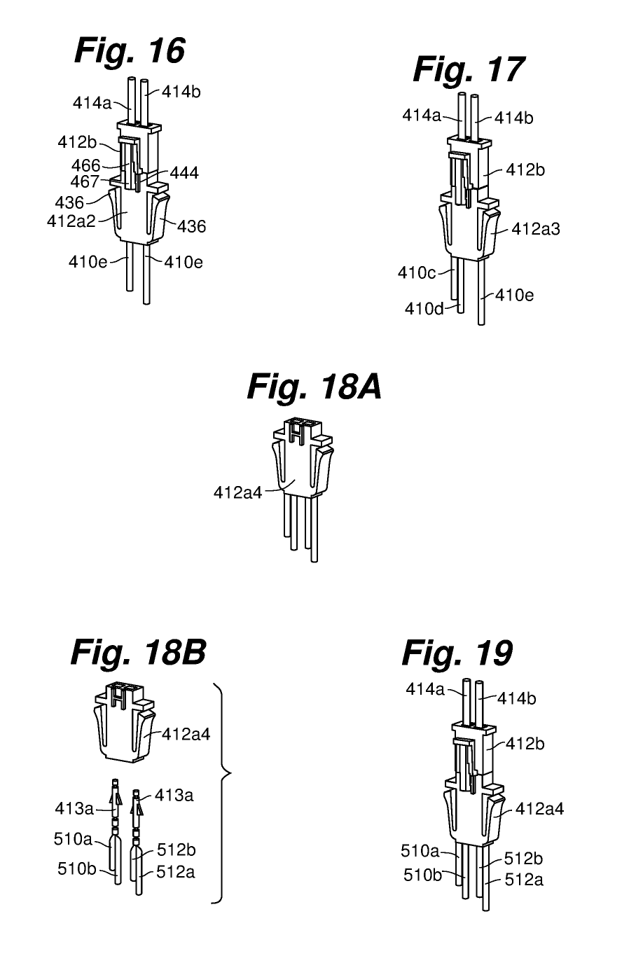

FIG. 17 depicts connector 412a3 coupled to connector 412b.

Referring also to FIGS. 12A and 12B, main portion 402 may, in an embodiment, include both 2-wire connectors 412a (412a2) and 3-wire connectors 412a (412a3). In an embodiment of main portion 402 having a series of consecutive connectors 412a and an end-power connector 408, as depicted, a first connector 412a and a last connector 412a are both 3-wire connectors 412a3, while the intermediate connectors 412a comprise 2-wire connectors. In an embodiment, such a configuration is used when lamp assemblies 418 are wired electrically in series.

FIGS. 18A and 18B depict a 4-wire version of connector 412a, namely, connector 412a4. In an embodiment, connector 412a4 is substantially the same as connector 412a2, or the same as connector 412a2, but configured to receive four wires, two in each side.

FIG. 19 depicts connector 412a4 detachably connected to connector 412b.

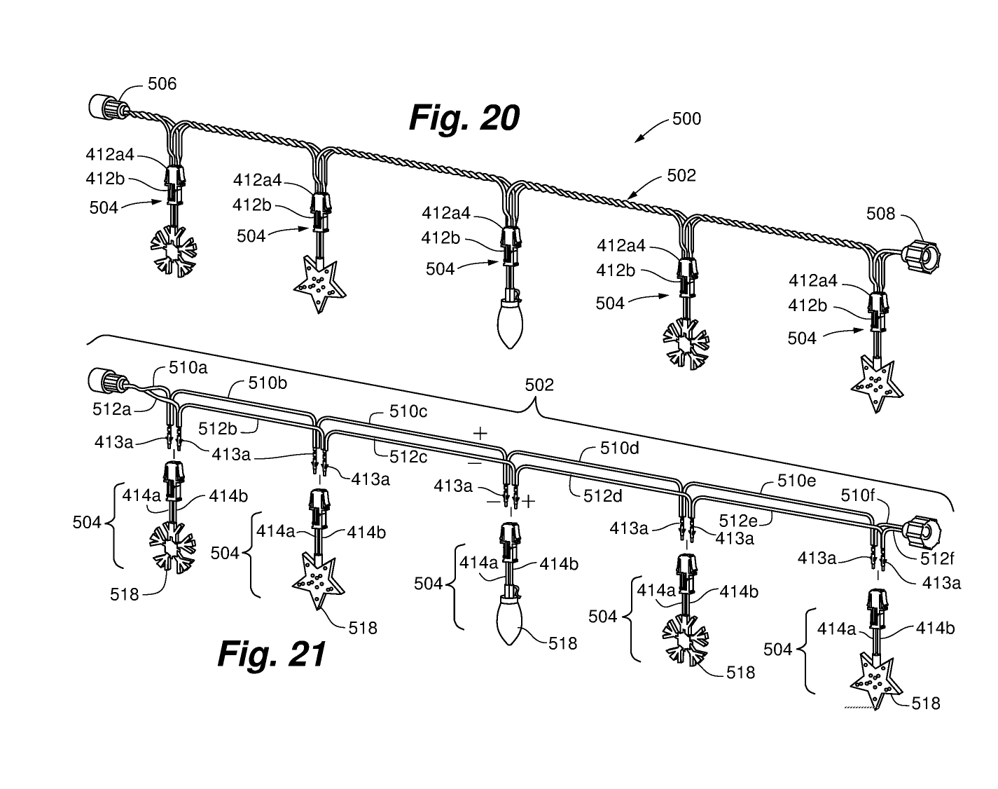

As described further below with respect to FIGS. 20 and 21, the use of 4-wire connectors 412a facilitate electrical connection of lamps in a parallel configuration.

Referring to FIGS. 20 and 21, an embodiment of decorative lighting assembly 500 is depicted. Decorative lighting assembly 500, in this embodiment, is similar to decorative lighting assembly 400 in many aspects, as will be described below. However, decorative lighting assembly 500 utilizes 4-wire connectors 412a, facilitating an electrically parallel connection of lighted-extension portions and lamp assemblies.

In an embodiment, decorative lamp assembly 500 includes main portion 502 and a plurality of lighting-extension portions 504. In an embodiment, main portion 502 extends horizontally, or longitudinally, while lighted-extension portions 504 extend vertically or longitudinally from main portion 502. In an embodiment, lighted-extension portions 504 extend perpendicularly or transversely to main portion 502, when assembled and in a display position.

In an embodiment, main portion 502 includes power plug 506, optional end-power connector 508, main wiring 510, and a plurality of connectors 412a.

Power plug 506 may be substantially the same as power plug 406 as depicted and described above, but may alternatively be of the type depicted. In an embodiment, power plug 506 may comprise multiple pin terminals for connecting to a power source, and in an embodiment, may also connect to a controller, or otherwise be configured to receive control or communication signals. In an embodiment, power plug 506 includes an attachment mechanism for coupling to a power source, such as a threaded portion configured to be inserted into a mating threaded cap, or other such attachment mechanism.

End-power connector 508, when present, is configured to connect to another decorative lighting assembly 500 having a plug similar to power plug 506.

Main wiring 510, in an embodiment, comprises a plurality of wires or wire segments. In an embodiment, and as depicted, main wiring 510 includes a first set of wires 510, including: wires 510a, 510b, 510c, 510d and 510e. Wires 510 are electrically connected to one another, and may be of a first electrical polarity, such as DC positive or AC live or hot. Main wiring 510 also includes a second set of wires 512 electrically connected to one another, including wires 512a, 512b, 512c, 512d, 512e and 512f. Wires 512 may be of a second polarity, such as DC negative or AC neutral. In embodiment, a DC voltage potential exists across wires 510 and 512 when decorative lighting assembly 500 is powered; in another embodiment, an AC voltage potential exists across wires 510 and 512 when decorative lighting assembly 500 is powered.

As depicted, ends of each of wires 510 and 512 are connected to terminals 413a, which are configured to be received by connectors 412a, which in the embodiment depicted, comprise 4-wire connectors 412a4, as described above.

As such, when connected to a power source, each pair of terminals 413a provides a voltage potential across the pair of terminals, and therefore at each connector 412a4, such that the connectors 412a4 are connected electrically in parallel.

Lighting-extension portions 504, in an embodiment, include connector 412b, wires 414a and 414b and one or more lamp assemblies 518. Connectors 412b electrically and mechanically connect to connectors 412a4 as described above with respect to FIGS. 13A-19.

Lamp assemblies 518 may comprise one, or a plurality of, incandescent or LED lamps electrically connected in parallel or in series. In an embodiment, lamp assemblies may comprise lighted ornaments.

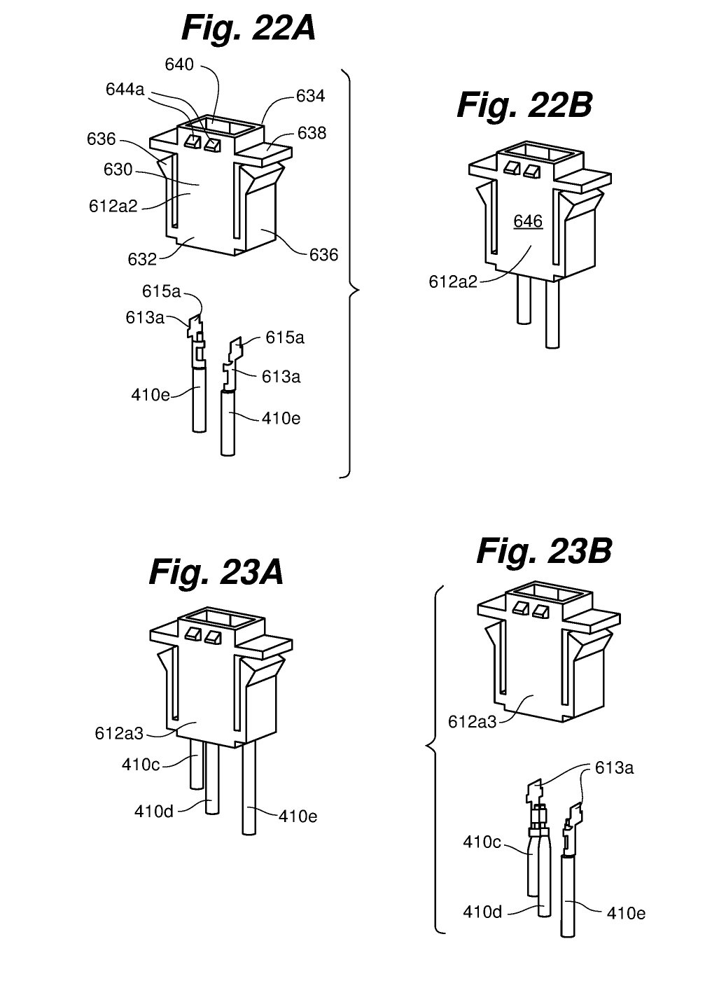

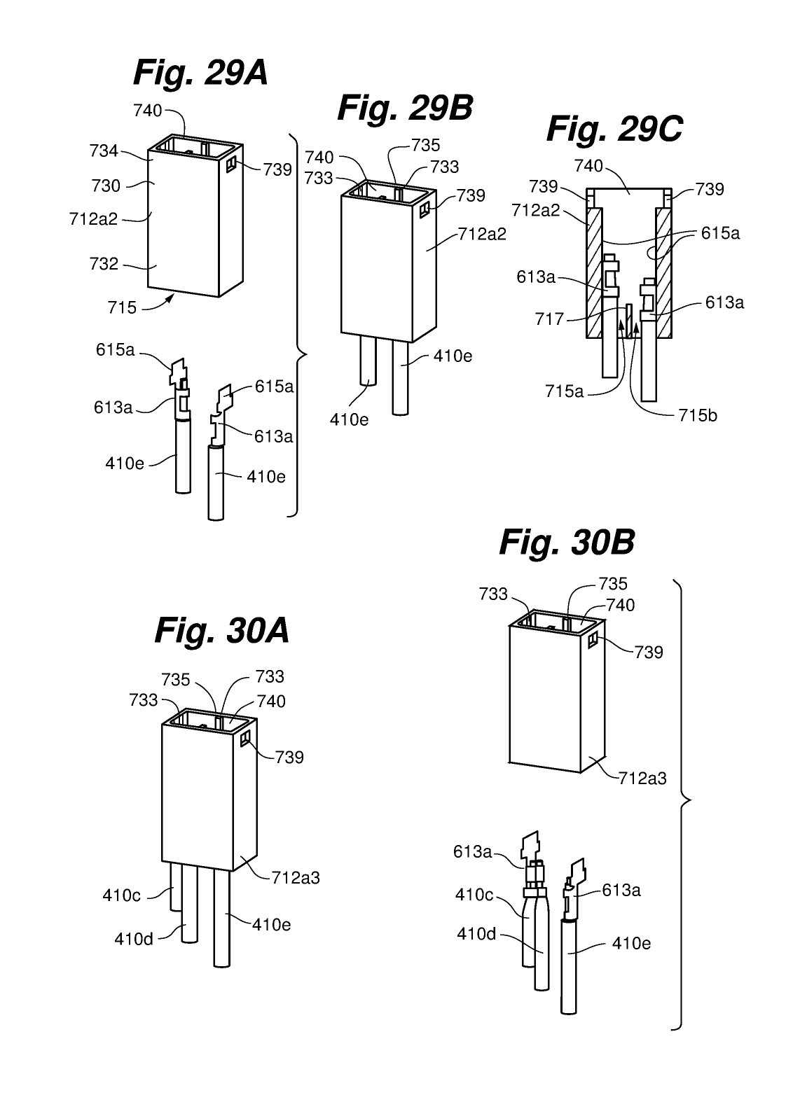

Although embodiments of decorative lighting assemblies 400 and 500 are depicted and described as including connector pairs 412a and 412b, other connectors and electrical terminals, with other features, may alternatively be used, such as those depicted in FIGS. 22A to 28 and those depicted in FIGS. 29A to 35.

Referring to FIGS. 22A to 28 connectors 612a and 612b with terminals 613a and 613b that differ somewhat from connectors 412a and 412b and terminals 413a and 413b are depicted. Connectors 612a and 612b include nearly all of the features of connectors 412a and 412b, including locking structures, locking terminals, user-grasping or gripping structures, wire-to-terminal connections in the interior of the bodies of the connectors, and so on. However, in embodiments depicted, connectors 612a and 612b include additional features, as described further below, including structural features that cause electrical connections of individual wires to be made inside connector 612a, but at different planes or heights, thereby maximizing distance between wire-to-wire and terminal-to-terminal connection points, and minimizing the chance of unwanted arcing between terminals of dissimilar polarities. It will be understood that connector pair 612a/612b shares features of connector pair 412a/412b, unless otherwise described or depicted.

Referring specifically to FIGS. 22A and 22B, connector 612a2 is depicted. In the embodiment depicted, connector 612a2 includes body portion 630, first end 632, and second end 634. In an embodiment, body portion 630 includes a pair of user-gripping portions 636 and a pair of tabs 638. User-gripping portions 636, in an embodiment, are configured to be gripped or grasped by a user to assist in separating connector 612a and connector 612b, and may comprise a pair of projections joined to body portion 630 at first end 632. User-gripping portions 636 may be configured to bend or pivot at their respective connection points to end 632. Optional tabs 638, when present may prevent a user's hand from slipping off of connector 412a, when gripping portions 636 and pulling.

First end 632 of connector 612a (612a2 in this embodiment), defines one or more openings or channels configured to receive terminals 613, including terminals 613a and 613b, and wires, such as 410e.

Second end 634 of connector 612a defines a receiving channel 640. Channel 640 may extend through body portion 630 to form the channel in first end 632. In an alternate embodiment, channel 640 defines a single channel near end 634 and two channels near end 632.

As described further below, channel 640 is each configured to receive a portion of connector 612b.

In an embodiment, body portion 630 includes lock portion 644a, comprising a pair of stops, on surface 646. Lock portion 644a is configured to detachably couple to a lock portion of connector 612b, as will be described further below.

Still referring to FIGS. 22A and 22B, a pair of terminals 613a are attached to a pair of wires 410e, respectively. Each terminal 613a includes an end portion 615a. End portion 615a is configured to fit into, and in some embodiments lock to, corresponding structure inside body portion 630, so that wires 410e may not be easily pulled out of connector 612a after assembly. In an embodiment, end portion 615a may generally be flat, with side projections as depicted. Another end portion of terminal 613a is configured to crimp to, or otherwise mechanically couple to, a conductor portion of a wire, such as wire 410e.

As depicted, terminal 613a, and a portion of wire 410e is inserted into connector body 630 at end 632, and into channel 640.

Referring to FIGS. 25A and 25B, an embodiment of connector 612b is depicted. In an embodiment, connector 612b is a male connector configured to couple with a female connector, such as connector 612a, including connector 612a2, and in some embodiments with any of connectors 612a2 (2-wire), 612a3 (3-wire), or 612a4 (4-wire). In an embodiment, connector 612b is simply a 2-wire connector, though in other embodiments not depicted, connector 612b is configured to receive 3-6 wires, including 3 wires or 4 wires.

In an embodiment, connector 612b includes body portion 660, first end 662, which is an insertion end, and second end 664 which is a wire-receiving end. In an embodiment, second end 664 defines flanged portion 667 that extends around a circumference of connector 612b and has an outside diameter larger than an outside diameter of body portion 660. Connector 612b also includes lock portion 666, and defines channels 668 and 670, separated by wall 671. In an embodiment, channels 668 and 670 extend the entire length of body portion 460.

First end 662, in an embodiment, is configured to be inserted into connector 612a. In an embodiment, first end 662 includes structure defining a shape complementary to channel 640, and thereby first end 662 is insertable into end 634 of connector 612a. In an embodiment, first end 662 comprises first side or portion 663 and second side or portion 665 both configured to fit into channel 640.

In an embodiment, and as depicted, each of first portion 663 and second portion 665 form side-by-side box shapes, or rectangular cuboids. In an embodiment, second portion 665 extends further away from end 662 as compared to first portion 663, and channels 668 and 670 extend respectively through first and second portions 663 and 665. In an embodiment, first portion 663 and second portion 665 define end diameters that are different. In one such embodiment, an end diameter of first portion 663 is smaller than that of second portion 665.

In an embodiment, first end 662 comprising first portion 663 and second portion 665 is narrower than second end 664, as depicted. A narrowing between ends 662 and 664 may occur at transition portion 673, which forms an angled portion. In an embodiment, the narrowing of end 662 leaves space for ends 615b of terminal 613b to be bent upwards and positioned adjacent first portion 663 and second portion 665, respectively, as described further below.

Lock portion 666, in an embodiment, comprises a projection or arm that is connected proximal end 464 of clip 412b, and having a free end 667 distal end 664, such that the free end may be moved away from body portion 660 and positioned adjacent stop tabs 644a of connector 612a2.

Also depicted in FIG. 25B is an embodiment of terminal 613b connected to a wire 414. In an embodiment, terminal 413b is substantially similar to terminal 413a, except that terminal 413b includes end 415b that extends downwardly and away from an opposite crimping end 611.

In an embodiment, a terminal 613b attached to a wire 414, such as wire 414a, is inserted into channel 668, such that end 615b projects outside channel 668 at first end 662, then is bent around an edge of first end 662, projecting upwardly, parallel to, and adjacent to, an outside surface of first portion 663 (not depicted, but substantially the same as depicted for terminal 613b and second end 665, which is depicted). In an embodiment, a portion of end 615b contacts ridge 673, and is bent at another point so that the tip of end 615b projects slightly outwardly and away from the outside surface of first portion 663.

Similarly, in an embodiment, a terminal 613b attached to a wire 414, such as wire 414b, is inserted into channel 670, such that end 615b projects outside channel 670 at second end 664, then is bent around an edge of second end 664, projecting upwardly, parallel to, and adjacent to, an outside surface of second portion 665. In an embodiment, end 615b is bent 180°. In an embodiment, a portion of end 615b contacts ridge 673, and is bent at another point so that the tip of end 615b projects slightly outwardly and away from the outside surface of second portion 665. The bend at the tip of end 615b may assist in securing terminal 613b in connector 412a2.

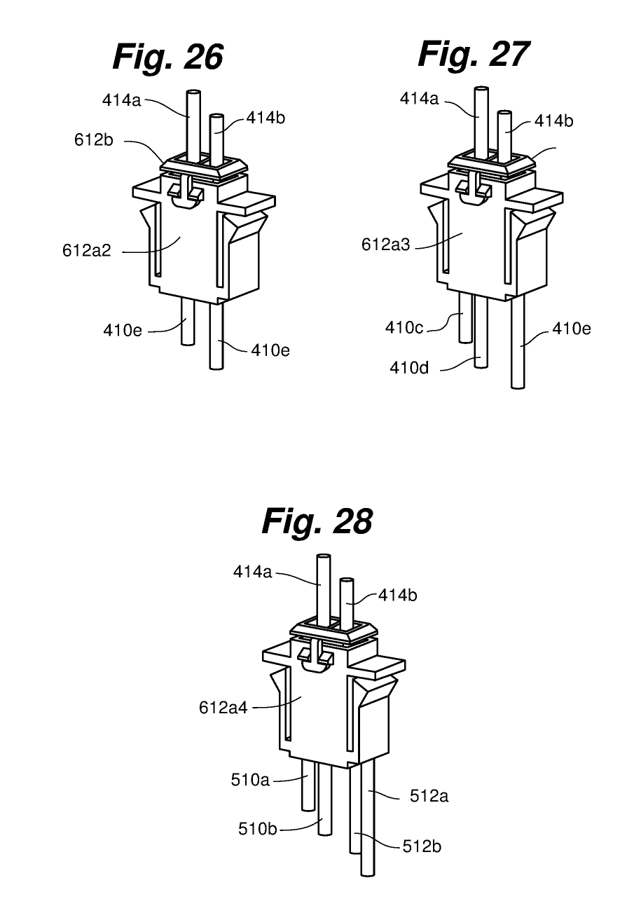

Referring to FIG. 26, connector 612a, specifically a 2-wire connector 612a2, is detachably coupled to connector 612b by inserting end 662 of connector 612b into channel 640 of end 634 of connector 612a. As depicted, lock portion 666 engages lock portion stop tabs 644a, thereby detachably coupling connector 612a2 to connector 612b. A user may disconnect connector 612a2 from connector 612b by lifting free end 667 away from the connectors, grasping user-grip portions 636, and pulling the connectors apart.

When coupled, each terminal 613a makes contact or electrical connection with a corresponding terminal 613b. In an embodiment, an exposed end 615b of terminal 613b (the end or portion adjacent an outside surface of first portion 663 or second portion 665) is positioned adjacent a corresponding end 615a of a terminal 613a, thereby making an electrical connection between pairs of terminals 613a and 613b inside connector 612a2.

Because first portion 663 is shorter, or does not project as far from end 664 as compared to second portion 664, terminal 613a and terminal 613b adjacent first portion 663 make electrical connection closer to second end 664 as compared to terminals 613a and 613b adjacent second portion 665. This structure that results in electrical contact points positioned at different longitudinal or vertical positions within connector 612a2 aids in reducing accidental arcing between terminals adjacent first portion 663 and second portion 665.

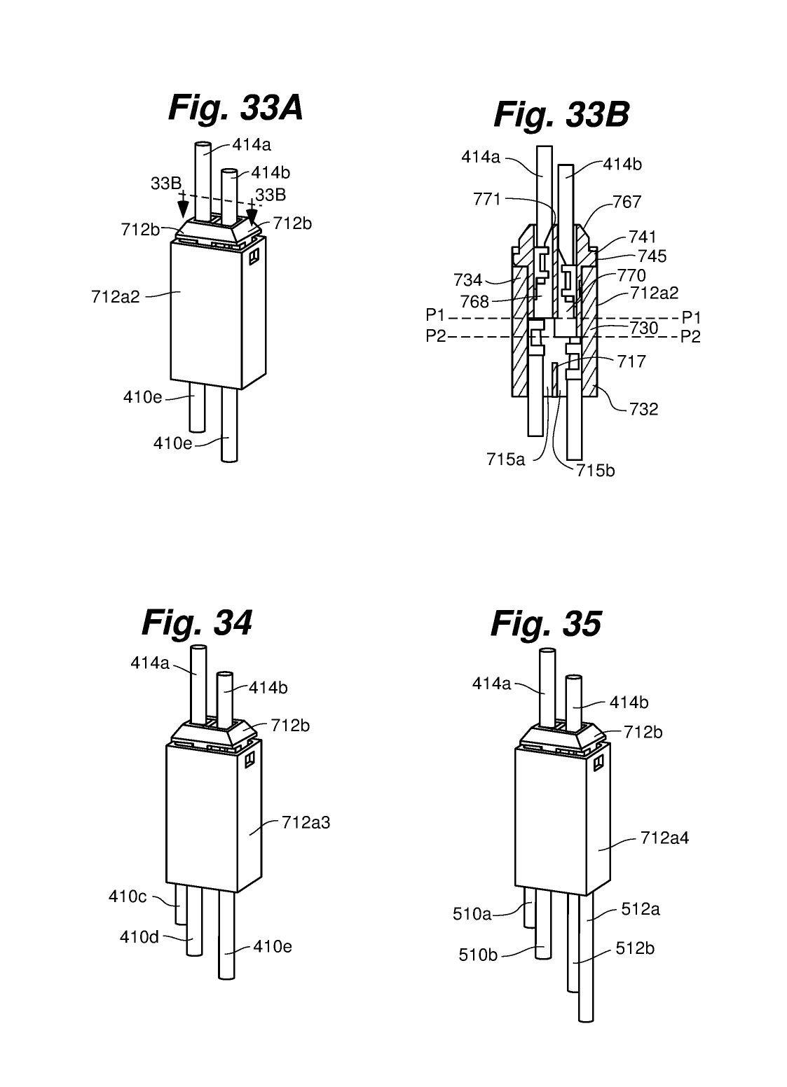

FIGS. 32C and 33B depict coupling of connectors 712a and 712b, which are similar to connectors 612a and 612b, provide cross sectional views depicting the concept of longitudinally shifted electrical connection points.

Referring to FIGS. 23A and 23B, an embodiment of connector 612a3 is depicted. In an embodiment, connector 612a3 is substantially the same as connector 612a2. In an embodiment, channel 640 may be modified to accommodate three wires instead of two wires.

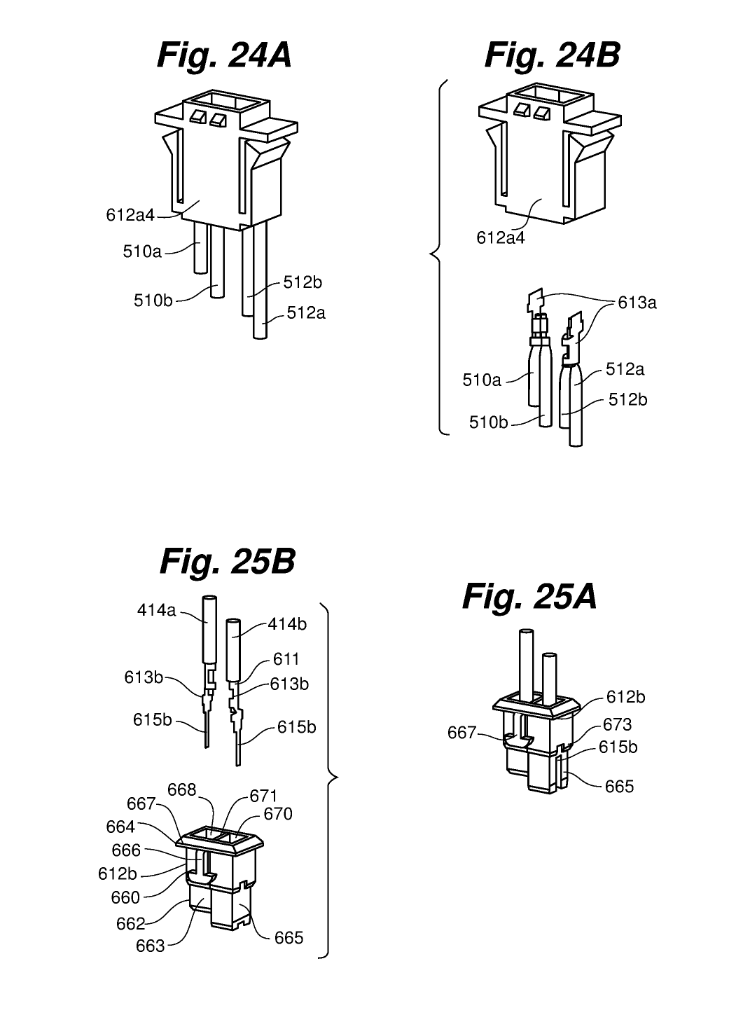

FIGS. 24A and 24B depict a 4-wire version of connector 612a, namely, connector 612a4. In an embodiment, connector 612a3 is substantially the same as connector 612a2. In an embodiment, channel 640 may be modified to accommodate four wires instead of two wires.

FIGS. 26-28 depict connectors 612a2, 612a3, and 612a4 detachably connected to connectors 412b, respectively.

Referring to FIGS. 29A to 35, another embodiment of a pair of connectors similar to connectors 412a/412b and 612a/612b, is depicted. Connector pair 712a and 712b is very similar to connector pair 612a/612b, sharing features of connector pair 612a/612b, unless otherwise described or depicted.

Referring specifically to FIGS. 29A, 29B and 29C, connector 712a2 is depicted. In the embodiment depicted, connector 712a2 includes body portion 730, first end 732, and second end 734.

First end 732 of connector 712a (712a2 in this embodiment), defines one or more openings or channels 715 configured to receive terminals 713, including terminals 713a and 713b, and wires, such as 410e. In the embodiment depicted, first end 732 defines two channels, channels 715a and 715b, separated by wall 717. Wall 717, in an embodiment, projects only partially into body portion 730, and assists in keeping wires and terminals positioned inside body portion 730.

Second end 734 of connector 712a2 defines a receiving channel 740. Channel 740 may extend through body portion 730 to channels 715a and 715b. In an alternate embodiment, body portion 730 and its second end 734 form only a portion of a single channel 740, and do not define separate, additional channels 715a and 715b. As described further below, channel 740 is each configured to receive a portion of connector 612b.

Second end 732, in an embodiment, also includes internal surface structure 733 for aligning and positioning 712b in receiving channel 740. In an embodiment, internal surface structure 733 includes vertical or longitudinal alignment ridge 735 projecting radially inward and extending longitudinally, vertically, or axially (with respect to an inserted wire axis). Alignment ridge 735 may be configured to be received by a corresponding slot or channel 737 on connector 712b. In an embodiment, alignment structure 733 may also include recesses in an inside surface of body portion 730.

In an embodiment, second end 734 of body portion 730 defines one or more lock openings 739, each configured to receive a portion of a locking projection or arm 741 of connector 712b, as described further below, for locking connector 712b into connector 712a2.

A pair of terminals 613a is attached to a pair of wires 410e, respectively. Each terminal 613a includes an end portion 615a. End portion 615a is configured to fit into, and in some embodiments lock to, corresponding structure inside body portion 730, so that wires 410e may not be easily pulled out of connector 712a2 after assembly. In an embodiment, end portion 615a may generally be flat, with side projections as depicted. Another end portion of terminal 613a is configured to crimp to, or otherwise mechanically couple to, a conductor portion of a wire, such as wire 410e.

As depicted, terminals 613a, and a portion of wires 410e are inserted into connector body 730 at end 732, and into and through channels 715a and 715b, and into channel 740.

Referring to FIGS. 32A, 32B and 32C, an embodiment of connector 712b is depicted. In an embodiment, connector 712b is a male connector configured to couple with a female connector, such as connector 712a, including connector 712a2, and in some embodiments with any of connectors 712a2 (2-wire), 712a3 (3-wire), or 712a4 (4-wire). In an embodiment, connector 712b is simply a 2-wire connector, though in other embodiments not depicted, connector 712b is configured to receive 3-6 wires, including 3 wires or 4 wires.

In an embodiment, connector 712b includes body portion 760, first end 762, which is an insertion end, and second end 764 which is a wire-receiving end. In an embodiment, second end 764 defines flanged portion 767 that extends around a circumference of connector 612b and has an outside diameter larger than an outside diameter of body portion 760. In an embodiment, connector 712b also includes a pair of lock portions 741, which may be arms attached proximal second end 734 having a free end 743. Free end 743 may include end portion 745 configured to be received in lock openings 739 of connector 712a2.

In an embodiment, 712a2 and body portion 730 defines channels 768 and 770, separated by wall 771. In an embodiment, channels 668 and 670 extend the entire length of body portion 460.

First end 762, in an embodiment, is configured to be inserted into connector 612a. In an embodiment, first end 762 includes structure defining a shape complementary to channel 740, and thereby first end 762 is insertable into end 734 of connector 712a2. In an embodiment, first end 762 comprises first side or portion 763 and second side or portion 765 both configured to fit into channel 740.

In an embodiment, and as depicted, each of first portion 763 and second portion 765 form side-by-side box shapes, or rectangular cuboids. In an embodiment, second portion 765 extends further away from end 762 as compared to first portion 763, and channels 768 and 770 extend respectively through first and second portions 763 and 765. In an embodiment, first portion 763 and second portion 765 define end diameters that are different. In one such embodiment, an end diameter of first portion 763 is smaller than that of second portion 665.

In an embodiment, first end 762 comprising first portion 763 and second portion 765 is narrower than second end 664, as depicted. A narrowing between ends 762 and 764 may occur at transition portion 773, which forms an angled portion. In an embodiment, the narrowing of end 762 leaves space for ends 615b of terminal 613b to be bent upwards and positioned adjacent first portion 763 and second portion 765, respectively, as described further below.

In an embodiment, a terminal 613b attached to a wire 414, such as wire 414a, is inserted into channel 768, such that end 615b projects outside channel 768 at first end 762, then is bent around an edge of first end 762, projecting upwardly, parallel to, and adjacent to, an outside surface of first portion 763 (not depicted, but substantially the same as depicted for terminal 613b and second end 765, which is depicted). In an embodiment, a portion of end 615b contacts ridge 773, and is bent at another point so that the tip of end 615b projects slightly outwardly and away from the outside surface of first portion 763.

Similarly, in an embodiment, a terminal 613b attached to a wire 414, such as wire 414b, is inserted into channel 770, such that end 615b projects outside channel 770 at second end 764, then is bent around an edge of second end 764, projecting upwardly, parallel to, and adjacent to, an outside surface of second portion 765. In an embodiment, a portion of end 615b contacts ridge 773, and is bent at another point so that the tip of end 615b projects slightly outwardly and away from the outside surface of second portion 765. The bend at the tip of end 615b may assist in securing terminal 613b in connector 712a2.

Referring to FIGS. 33A and 33B, a connector 712a, specifically a 2-wire connector 712a2, is detachably coupled to connector 712b by inserting end 762 of connector 712b into channel 740 of end 734 of connector 712a2. As depicted, end portions 745, which project transversely to body portion 730, are received by lock openings 739, thereby locking connector 712b to connector 712a2. In this embodiment, only a small portion of free end 743 of arm 741, i.e., a portion of end 745 projects out of a lock opening 739, such that a user cannot easily disconnect or detach connector 712b from connector 712a2, without using a tool of some sort to press end 745 into channel 740 before pulling apart. Such a configuration ensures that the connectors are not easily detached from one another, thereby exposing potentially live electrical conductors. Such a configuration enhances the safety of the decorative light assembly, such as decorative light assemblies 400 and/or 500.

When coupled, each terminal 613a makes contact or electrical connection with a corresponding terminal 613b. In an embodiment, an exposed end 615b of terminal 613b (the end or portion adjacent an outside surface of first portion 663 or second portion 665) is positioned adjacent a corresponding end 615a of a terminal 613a, thereby making an electrical connection between pairs of terminals 613a and 613b inside connector 712a2.

Similar to connector pair 612a2/612b, because first portion 763 is shorter, or does not project as far from end 764 as compared to second portion 764, terminal 613a and terminal 613b adjacent first portion 763 make electrical connection closer to second end 764 as compared to terminals 613a and 613b adjacent second portion 765. This structure that results in electrical contact points positioned at different longitudinal or vertical positions within connector 712a2 aids in reducing accidental arcing between terminals adjacent first portion 763 and second portion 765. As depicted, electrical connection between first portion 763 terminals occurs at or above plane P1, while electrical connection between first portion 765 terminals occurs at or above plane P2. In an embodiment, and as depicted, plane P1 is a horizontal plane defined at an end of first portion 763, while plane P2 is a horizontal plane defined at an end of second portion 765.

Another feature of connector pair 712a/712b is that wall 771 provides an insulative barrier between terminal ends 615a of first and second portions 763 and 765, thereby reducing the chance of arcing between terminals of opposite polarity.

Referring to FIGS. 30A and 30B, an embodiment of connector 712a3 is depicted. In an embodiment, connector 612a3 is substantially, or exactly, the same as connector 712a2. In an embodiment, channel 740 may be modified, including enlarging body portion 730, to accommodate three wires instead of two wires.

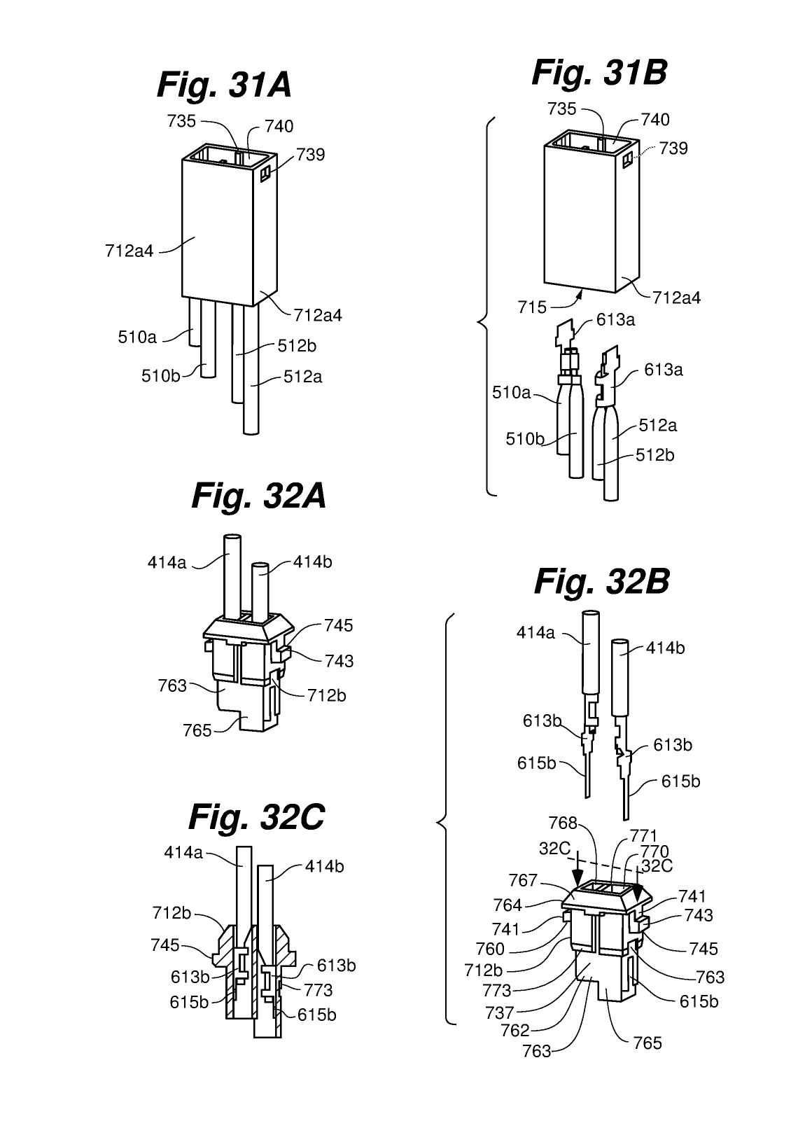

FIGS. 31A and 31B depict a 4-wire version of connector 712a, namely, connector 712a4. In an embodiment, connector 712a4 is substantially the same as connector 712a2. In an embodiment, channel 740 may be modified to accommodate four wires instead of two wires.

FIGS. 34-35 depict connectors 712a2, 712a3, and 712a4 detachably connected to connectors 712b, respectively.

As described above in detail, any of connector pairs 412a/412b, 612a/612b or 712a/712b may be used with decorative lighting assemblies 400 and 600.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A tangle-resistant decorative lighting assembly, comprising:
a main portion including a plurality of wires and a plurality of connectors, the plurality of connectors including a first connector and a second connector; and
a plurality of lighted-extension portions extending transversely from the main portion, the plurality of lighted-extension portions including a first lighted extension portion and a second lighted extension portion.
